(19) United States
(12) Patent Application Publication
(10) Pub. No.: US 2026/0089177 A1
(43) Pub. Date: Mar. 26, 2026

(54) Prediction of False Positive Cybersecurity Detections

(71) Applicant: CrowdStrike, Inc., Sunnyvale, CA (US)

(72) Inventors: Vitaly Zaytsev, Beaverton, OR (US); Ryan Inghilterra, Carlsbad, CA (US); Joel Robert Spurlock, Portland, OR (US); Michael Avraham Brautbar, Wayland, MA (US)

(73) Assignee: CrowdStrike, Inc., Sunnyvale, CA (US)

(21) Appl. No.: 18/894,372

(22) Filed: Sep. 24, 2024

(51) Int. Cl. H04L 9/40

(52) U.S. Cl. CPC H04L 63/1425

(57) ABSTRACT

Prediction of false positive cybersecurity detections greatly improves computer functioning. When a client device reports a cybersecurity detection, the cybersecurity detection is compared to a false positive cybersecurity detection profile. The false positive cybersecurity detection profile represents false positive characteristics associated with false positive cybersecurity detections. If the cybersecurity detection conforms to the false positive cybersecurity detection profile, then the cybersecurity detection may be categorized as false positive and normal operation. If, however, the cybersecurity detection fails to conform to the false positive cybersecurity detection profile, then the cybersecurity detection may be categorized as true positive and abnormal operation. The identification of false positive cybersecurity detections produces a more accurate detection of legitimate computer usage/activity.

### BACKGROUND

The subject matter described herein generally relates to electrical communications and to computer security and, more particularly, the subject matter relates to monitoring computer behavior.

False positives are a problem in the cybersecurity industry. Cyber attackers are constantly evolving and obfuscating their malicious schemes. Legitimate software services are also constantly evolving. The cybersecurity industry is thus always striving to improve threat detection in a very dynamic environment. Consequently, many false positive cybersecurity detections are generated, and these false positive cybersecurity detections waste significant computer and human resources and electrical energy.

### SUMMARY

Prediction of false positive cybersecurity detections produces faster and more accurate detections of normal computer behavior. Cybersecurity services receive thousands of reports of supposedly suspicious computer activities. Many of these reports, though, are determined to be false positives. That is, the supposedly suspicious computer activities are actually determined to be normal operation. Much time, computer resources, and electrical energy were thus wasted in analyzing these thousands of false positive reports. A false positive prediction service, though, predicts which cybersecurity detections are false positives. The false positive prediction service, in other words, preliminarily screens and a priori predicts false positives, before significant time, computer, network, and electrical power resources are consumed. The false positive prediction service thus quickly and accurately predicts false positive cybersecurity detections that represent normal computer behavior.

False positive cybersecurity detections are profiled. Each cybersecurity detection, for example, may be compared to a false positive cybersecurity detection profile. The false positive cybersecurity detection profile represents false positive characteristics associated with false positive cybersecurity detections. The false positive cybersecurity detection profile thus represents common patterns of false positive computer behavior and/or recurring false positive cybersecurity detections. If a cybersecurity detection conforms to the false positive cybersecurity detection profile, then the cybersecurity detection may be categorized as a false positive. A client device and/or a cloud service, for example, is normally operating. If, however, the cybersecurity detection fails to conform to the false positive cybersecurity detection profile, then the cybersecurity detection may be categorized as a true positive. The cybersecurity detection, in other words, may be evidence of abnormal operation by the client device and/or by the cloud service. Normal operational predictions are far more accurate by using false positive characteristics. Hardware and software resources are not wasted analyzing false positives, and much less electrical energy is consumed.

### BRIEF DESCRIPTION OF THE SEVERAL VIEWS OF THE DRAWINGS

The features, aspects, and advantages of predicting false positive cybersecurity detections are understood when the following Detailed Description is read with reference to the accompanying drawings, wherein:

FIGS. 1-3 illustrate some examples of predicting false positive cybersecurity detections;

FIGS. 4-6 illustrate examples of machine learning;

FIGS. 7-9A & 9B illustrate examples of entitative batching;

FIGS. 10-12 illustrate examples of detection sourcing;

FIGS. 13-14 illustrate more examples of predicting the false positive cybersecurity detections;

FIGS. 15-17 illustrate more examples of predicting the false positive cybersecurity detections using three-dimensional graphical data;

FIG. 18 illustrates examples of local endpoint prediction;

FIGS. 19-21 illustrate examples of methods or operations that generate false positive cybersecurity predictions; and

FIG. 22 illustrates a more detailed example of the operating environment.

### DETAILED DESCRIPTION

False positives are a concern in the cybersecurity industry. As we all know, nearly every day there is another hack that steals account passwords, business data, and personal information. Email inboxes often contain phishing emails, malicious website links, and virus attachments. Text messages may also contain malicious links and content. Indeed, hackers are always trying new schemes to steal information. Cybersecurity services, though, can protect computers, smartphones, and other devices from cyber attacks. Cybersecurity services detect computer activities and behaviors that may indicate suspicious or even malicious operation. Unfortunately, though, many computer activities and behaviors are later determined to be benign. That is, a cybersecurity service may receive thousands of reports of supposedly suspicious computer activities and behaviors. Much time and computer resources are then spent analyzing these thousands of reports. A high proportion of the reports, though, are determined to be false positives. These false positives, in plain words, are false alarms. The supposedly suspicious computer activities and behaviors are actually determined to be normal operation. Time, computer resources, and electrical energy were thus wasted in analyzing these thousands of false positive reports.

Some examples relate to predicting false positive cybersecurity detections. Each cybersecurity detection represents a report of supposedly suspicious computer activities and behaviors. Here, though, a false positive prediction service pre-screens each cybersecurity detection. The false positive prediction service compares the cybersecurity detections to a false positive cybersecurity detection profile. The false positive cybersecurity detection profile contains data that describes or represents characteristics associated with false positive cybersecurity detections. The false positive prediction service, in other words, analyzes and profiles the many false positive reports. The false positive prediction service learns the characteristics that represent the false positive reports. So, when each cybersecurity detection is preliminarily assessed, the false positive prediction service determines whether the cybersecurity detection shares the same profile characteristics that represent the false positive reports.

The false positive prediction service saves time, computer resources, and electrical energy. If the cybersecurity detection shares the same profile characteristics as other false positive reports, then the false positive prediction service may quickly predict yet another false positive. The cybersecurity detection may thus be labeled or characterized as a similar false positive report. Little or no further analysis is needed, as the cybersecurity detection represents normal operation. Time, computer resources, and electrical energy may be saved and reallocated to more productive tasks. The cybersecurity detection, in simple words, is safe and poses little or no threat.

The false positive prediction service, however, may also confirm abnormal operation. When the cybersecurity detection is compared to the false positive cybersecurity detection profile, the cybersecurity detection may differ from the characteristics associated with the false positive reports. Because the cybersecurity detection does not share or match the profile characteristics, the cybersecurity detection does not resemble other false positives. The cybersecurity detection may thus be classified as a true positive report of abnormal operation. The false positive prediction service may then assign the cybersecurity detection to other computers or services that perform a greater, deep-dive analysis. The cybersecurity detection deserves more time, computer resources, and electrical energy.

Predicting false positive cybersecurity detections will now be described more fully hereinafter with reference to the accompanying drawings. Predicting false positive cybersecurity detections, however, may be embodied in many different forms and should not be construed as limited to the examples set forth herein. These examples are provided so that this disclosure will be thorough and complete and fully convey predicting false positive cybersecurity detections to those of ordinary skill in the art. Moreover, all the examples of predicting false positive cybersecurity detections are intended to encompass both structural and functional equivalents thereof. Additionally, it is intended that such equivalents include both currently known equivalents as well as equivalents developed in the future (i.e., any elements developed that perform the same function, regardless of structure).

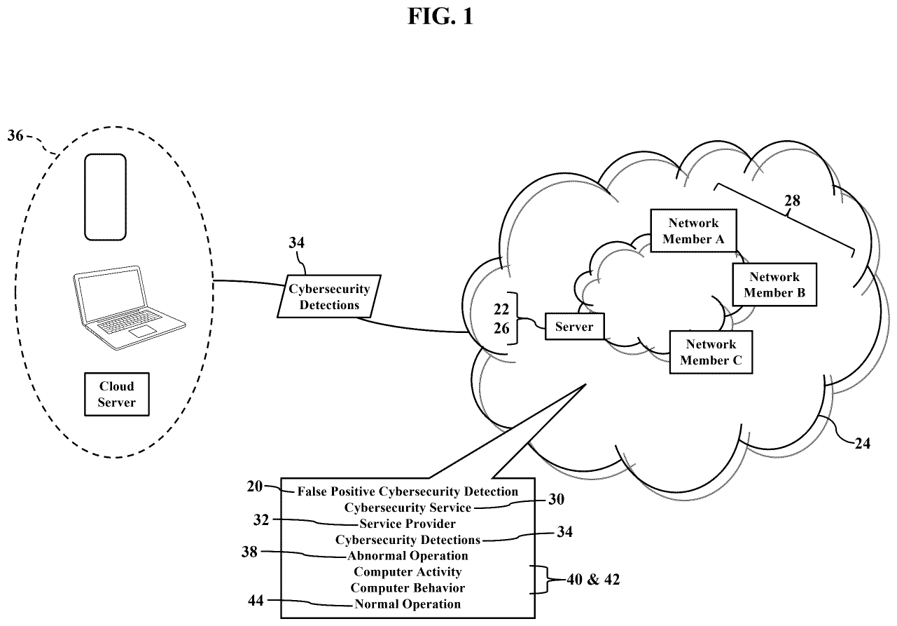

FIGS. 1-3 illustrate some examples of predicting false positive cybersecurity detections 20. A computer system 22 operates in a cloud computing environment 24. FIG. 1 illustrates the computer system 22 as a server 26. The computer system 22, though, may be any processor-controlled device, as later paragraphs will explain. In this example, the server 26 communicates via the cloud computing environment 24 (e.g., public Internet, private network, and/or hybrid network) with other servers, devices, computers, or other networked members 28 operating within, or affiliated with, the cloud computing environment 24. The cloud computing environment 24 provides a cybersecurity service 30 on behalf of a service provider 32. The cybersecurity service 30 receives reports of cybersecurity detections 34 from customers and users (such as client devices 36). The cloud computing environment 24 inspects and analyzes the cybersecurity detections 34 to determine cybersecurity threats. Some of the cybersecurity detections 34, for example, are legitimate reports of abnormal operation 38 and may indicate suspicious, or even malicious, computer activity 40 and/or computer behavior 42. Many of the cybersecurity detections 34, though, are determined to be benign, normal operation 44. Many of the cybersecurity detections 34, in other words, are the false positive cybersecurity detections 20.

The false positive cybersecurity detections 20 greatly waste resources. The cybersecurity service 30 dedicates and prioritizes much hardware (e.g., processor and memory) and network resources to analyzing the cybersecurity detections 34. The cybersecurity service 30 also consumes much electrical power when analyzing the cybersecurity detections 34. When many of the cybersecurity detections 34, though, are determined to be normal operation 44, the cybersecurity service 30 has thus wasted hardware, network, and power resources on the false positive cybersecurity detections 20. Wrong security alerts triggered by benign metadata and other computer activity/behavior 40/42 are thus a concern in the security industry.

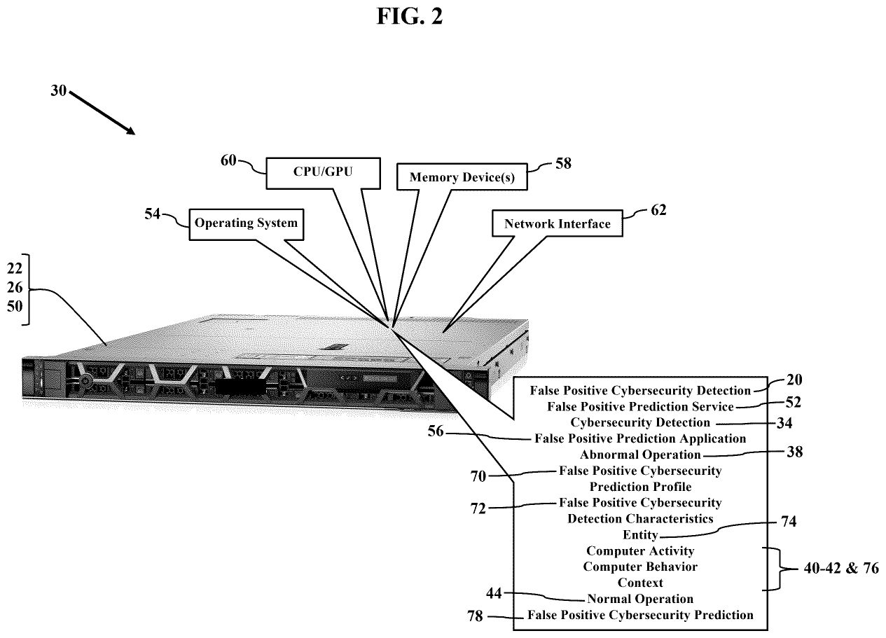

As FIG. 2 illustrates, though, the server 26 is programmed to identify the false positive cybersecurity detections 20. FIG. 2 illustrates the server 26 as a rack server 50, which is commonly installed in server rooms and in server farms. The server 26 performs a false positive prediction service 52. The server 26 predicts which cybersecurity detections 34 are the false positive cybersecurity detections 20, before the cloud computing environment 24 (illustrated in FIG. 1) expends significant resources. The false positive prediction service 52 preliminarily screens and a priori predicts the false positive cybersecurity detections 20. When the cloud computing environment 24 receives the cybersecurity detection 34, the nodal networked members 26 (illustrated in FIG. 1) of the cloud computing environment 24 may forward the cybersecurity detection 34 to the server 26 that performs the preliminary false positive prediction service 52. The false positive prediction service 52 far more accurately predicts which of the cybersecurity detections 34 are actually the false positive cybersecurity detections 20. The false positive prediction service 52 greatly reduces the number of the cybersecurity detections 34 that waste hardware, network, and power resources.

The server 26 performs the fast and elegant false positive prediction service 52. The server 26 stores and executes an operating system 54. The server 26 also stores a false positive prediction application 56 in a memory device 58. The server 26 has a hardware processor with cores 60 (illustrated as “CPU/GPU”) that reads and executes the operating system 54 and the false positive prediction application 56. The server 26 also has network interfaces 62 to multiple communications networks (such as the cloud computing environment 24 illustrated in FIG. 1), thus allowing bi-directional communications with other networked devices and services. The false positive prediction application 56 has programming code or instructions that cause the server 26 to perform operations, such as predicting whether the cybersecurity detection 34 is the false positive cybersecurity detection 20 or the abnormal operation 38.

The server 26 inspects the cybersecurity detection 34. When the server 26 receives the cybersecurity detection 34, the server 26 may ingest the cybersecurity detection 34 as an input. The server 26 may acquire log data that further describe, explains, or surrounds the cybersecurity detection 34 (as later paragraphs explain). The server 26 then executes the false positive prediction application 56 as a false positive predictor engine. The false positive prediction application 56 instructs or causes the server 26 to compare the cybersecurity detection 34 to a false positive cybersecurity detection profile 70. While the false positive cybersecurity detection profile 70 may be remotely stored and maintained by the cloud computing environment 24, FIG. 2 illustrates local storage in the memory device 58 of the server 26. The false positive cybersecurity detection profile 70 contains or describes data representing false positive cybersecurity detection characteristics 72, perhaps associated with a user, group of users, device(s), company/employer, or other entity 74.

The false positive cybersecurity detection profile 70 describes the false positive cybersecurity detections 20. The false positive cybersecurity detection profile 70 defines, specifies, or represents predetermined or known computer activities 40, computer behaviors 42, and/or computer contexts 76 that have been assessed or prescribed as the safe or normal operation 44. The false positive cybersecurity detection profile 70, in other words, may describe habitual, routine, current, and/or harmless computer activities 40, computer behaviors 42, and/or computer contexts 76 associated with a user, group of users, employees, company, employer, or other entity 74. The false positive cybersecurity detection profile 70 may represent historical, behavioral past usage associated with the same entity 74. The false positive cybersecurity detection profile 70 may represent historical logs, information, actions, inputs, bits/bytes, values, averages/ranges, and/or other false positive cybersecurity detection characteristics 72 that is/are known to indicate the false positive cybersecurity detections 20. The false positive cybersecurity detection profile 70, as a simple example, may store or represent statistical ranges or values (e.g., +30 standard deviations) describing past or historical false positive cybersecurity detection characteristics 72 that have been previously logged and/or assessed as the normal operation 44. The false positive cybersecurity detection profile 70, however, may also store, reflect, and/or represent more contemporaneous or even real-time false positive cybersecurity detection characteristics 72 that describe the false positive cybersecurity detections 20 and/or the normal operation 44. The false positive cybersecurity detection profile 70 thus contains or represents a rich description of the historical and current false positive cybersecurity detection characteristics 72 that reflect the false positive cybersecurity detections 20.

A false positive cybersecurity prediction 78 may be generated. Once the cybersecurity detection 34 is compared to the false positive cybersecurity detection profile 70, the false positive prediction application 56 may generate the false positive cybersecurity prediction 78. As an example, if the cybersecurity detection 34 equals, matches, satisfies, lies within, or conforms to the false positive cybersecurity detection profile 70, then the false positive prediction application 56 may determine that the cybersecurity detection 34 is the false positive cybersecurity detection 20. The cybersecurity detection 34, and its associated computer activities/behaviors/contexts 40/42/76, have been historically observed, concurrently observed, and/or assessed as the safe or normal operation 44. Because the cybersecurity detection 34 conforms to the false positive cybersecurity detection profile 70, the false positive prediction application 56 may further label or categorize the cybersecurity detection 34 as the safe or normal operation 44. Moreover, because the cybersecurity detection 34 conforms to the false positive cybersecurity detection profile 70, the false positive prediction application 56 may further predict, label, and/or categorize the cybersecurity detection 34 as the false positive cybersecurity detection 20. The false positive prediction application 56 may thus de-escalate, cancel, or even terminate any further inspection, analysis, or review of the cybersecurity detection 34 and its associated computer activities/behaviors/contexts 40/42/76. The server 26, and the cybersecurity service 30, may thus reallocate processor, memory, and network resources to other tasks.

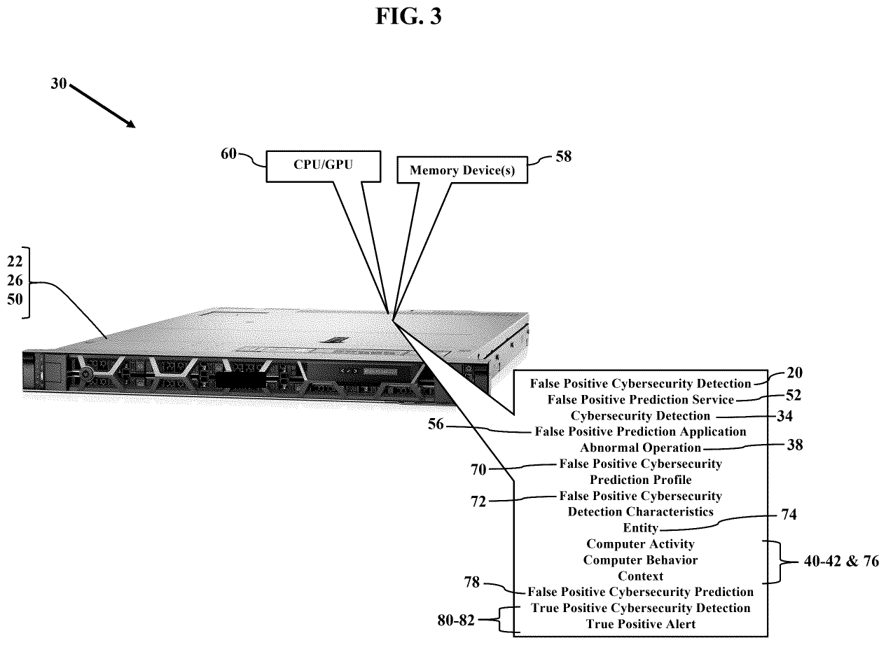

FIG. 3 illustrates examples of the predictive, abnormal operation 38. The server 26 (again illustrated as the rack server 50) may also be programmed to detect abnormal computer activities/behaviors/contexts 40/42/76 associated with the user, group, device(s), company/employer/organization, or other entity 74. The false positive prediction application 56 instructs or causes the server 26 to compare the cybersecurity detection 34 to the false positive cybersecurity detection profile 70. The false positive cybersecurity detection profile 70 contains or describes data representing the false positive cybersecurity detection characteristics 72, perhaps also associated with the user/group/company/employer/entity 74. The false positive prediction application 56 instructs or causes the server 26 to generate the false positive cybersecurity prediction 78. In these examples, though, the cybersecurity detection 34 fails to conform to the false positive cybersecurity detection profile 70. That is, the cybersecurity detection 34 is unequal to, does not match, does not satisfy, or lies outside of the false positive cybersecurity detection profile 70. When the cybersecurity detection 34 fails to conform to the false positive cybersecurity detection profile 70, then the false positive prediction application 56 may determine that the cybersecurity detection 34 is unlike, or does not resemble, false positives. The false positive prediction application 56 may determine that the cybersecurity detection 34 describes the abnormal operation 38. The cybersecurity detection 34, and its associated computer activities/behaviors/contexts 40/42/76, does not conform to historical/current false positives, or the cybersecurity detection 34 has been prescribed as known abnormal operation 38. Because cybersecurity detection 34 fails to conform to the false positive cybersecurity detection profile 70, the false positive prediction application 56 may further label or categorize the cybersecurity detection 34 as the abnormal operation 38. Moreover, because the cybersecurity detection 34 does not conform to the false positive cybersecurity detection profile 70, the false positive prediction application 56 may label or categorize the cybersecurity detection 34 as a true positive cybersecurity detection 80. The false positive prediction application 56 may further authorize and/or escalate a deeper analysis or review of the cybersecurity detection 34, such as by instructing the server 26 to generate a true positive alert or other notification 82 indicating the cybersecurity detection 34 represents the true positive cybersecurity detection 80 and/or the abnormal operation 38. The true positive alert 82 may be sent to any network address (e.g., IP address) associated with any supervisory or notification system associated with the cloud computing environment 24 (illustrated in FIG. 1).

The false positive prediction service 52 is especially helpful to enterprise networks. Many businesses, governmental entities, and other corporate enterprises have Security Operations Centers (or SOCs) that oversee computer networks. The SOC monitors computers and computer networks for suspicious indicators of breaches or other cyberattacks. When suspicious indicators are detected, the SOC investigates and takes remedial actions. The SOC may use a System Integrated Event Monitoring (or SIEM) solution which monitors computers and computer networks for suspicious indicators. The SOC and the SIEM, though, may receive thousands of the cybersecurity detections 24, and each cybersecurity detection 34 may require much time, computer resources, and electrical energy to investigate. Indeed, many cybersecurity detections 34 require a sophisticated analysis that may even require input from veteran, subject matter expert analysts. The false positive prediction service 52, though, preliminarily and accurately prescreens the cybersecurity detections 34. The false positive prediction service 52 may thus predictively filter or weed-out those cybersecurity detections 34 that satisfy the false positive cybersecurity detection profile 70. Time, computer resources, and electrical energy may thus be reserved for the true positive cybersecurity detections 80.

The false positive cybersecurity detection profile 70 represents a revolutionary change and development in cybersecurity. Conventional cybersecurity services and products rely on anomaly detection. Conventional cybersecurity schemes, in other words, use complicated rules and/or an anomaly classifier to detect outlier/abnormal computer activities. Because conventional cybersecurity schemes detect anomalies, conventional cybersecurity schemes produce many alerts of unknown and suspicious computer activities. Conventional cybersecurity schemes are simply flooded with potential threats that must be investigated, and many or most are false positives. The false positive prediction service 52, in contradistinction, profiles false positives to expand the range of safe or normal operation 44. The false positive prediction service 52 is thus far more complex than conventional anomaly detection cybersecurity schemes. The false positive prediction service 52 does not utilize outlier detection and, instead, detects safe or normal operation 44. The false positive prediction service 52, in plain words, does not mitigate mistaken detections. The false positive prediction service 52 prevents mistaken detections by far more accurately profiling the safe or normal operation 44.

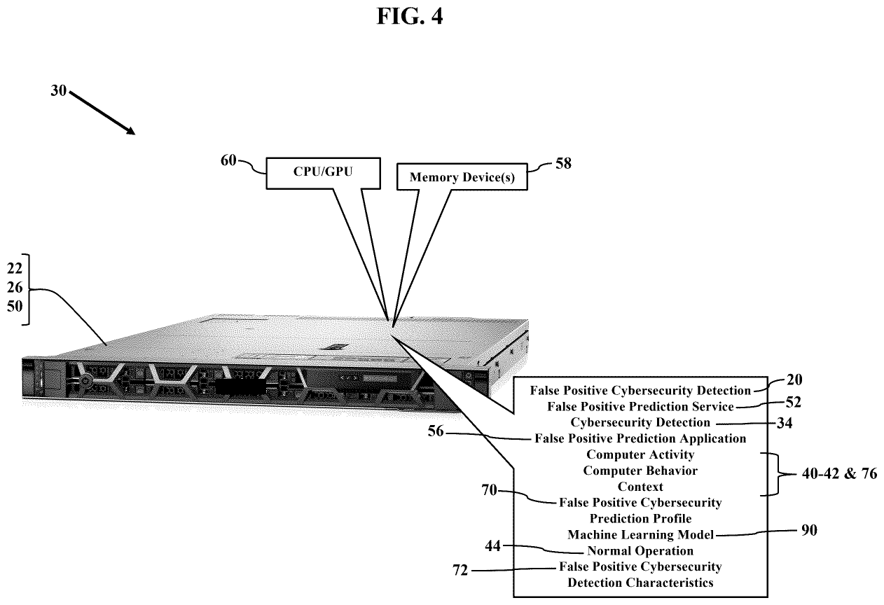

FIGS. 4-6 illustrate examples of machine learning. When the server 26 (again illustrated as the rack server 50) receives the cybersecurity detection 34, the server 26 executes the false positive prediction application 56 as the predictor engine. The server 26 may ingest the cybersecurity detection 34 (and/or its associated computer activities/behaviors/contexts 40/42/76) as an input, and the false positive prediction application 56 instructs the server 26 to compare the cybersecurity detection 34 to the false positive cybersecurity detection profile 70. In this example, the false positive cybersecurity detection profile 70 is generated by a machine learning model 90. The machine learning model 90 may be a network resource or service provided by the cloud computing environment 24 (illustrated in FIG. 1). The machine learning model 90 may also be resource or service provided by a contractor or third party service provider (not shown for simplicity). For simplicity, though, FIG. 4 illustrates the machine learning model 90 as a service, module, or function provided by the server 26. The server 26 may thus execute the machine learning model 90 to build the false positive cybersecurity detection profile 70. The machine learning model 90 generates the false positive cybersecurity detection profile 70 to statistically identify (e.g., +3σ standard deviations) the false positive cybersecurity detections 20. Because the machine learning model 90 builds the false positive cybersecurity detection profile 70, the machine learning model 90 may more accurately predict a range of the safe or normal operation 44, in terms of past/historical/habitual/current false positive cybersecurity detection characteristics 72.

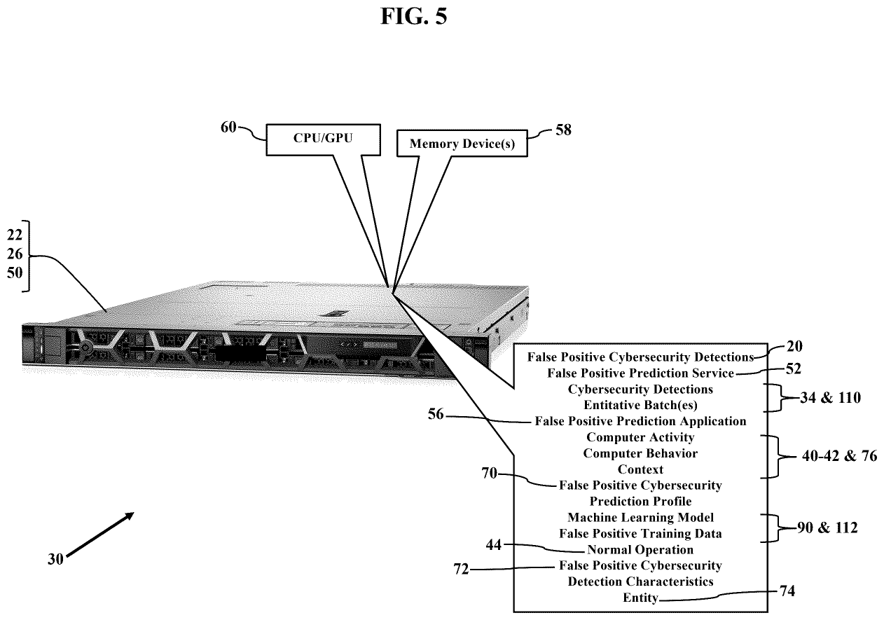

FIG. 5 illustrates more examples of the false positive cybersecurity detection profile 70. The false positive cybersecurity detection profile 70 may specify different values and/or combinations of values of the false positive cybersecurity detection characteristics 72 associated with the entity 74, perhaps occurring within the same timeframe(s), that are predetermined to be the false positive cybersecurity detections 20. The false positive cybersecurity detection profile 70, for example, may represent singular or sequences of operating system events that describe the false positive cybersecurity detections 20 and assessed as the normal operation 44. The false positive cybersecurity detection profile 70 may additionally or alternatively represent API calls, IP addresses, usernames, network events, network traffic, cloud activity logs, identity protection events, and other data that describe the false positive cybersecurity detections 20 and assessed as the normal operation 44. The false positive cybersecurity detection profile 70 thus describes the computer activities/behaviors/contexts 40/42/76 that have been pre-defined or pre-categorized as the normal operation 44. The false positive cybersecurity detection profile 70, as another example, represents the false positive cybersecurity detection characteristics 72 that have been historically logged, observed, or attributed to the common entity 74. The false positive cybersecurity detection characteristics 72, as still more examples, may represent individual and collective computer activities/behaviors/contexts 40/42/76 observed or learned over time when providing the cybersecurity service 30 to the same user/group/company/employer/entity 74. The false positive cybersecurity detection profile 70 may thus define or describe normal or expected process events, API calls, communications, activities, behaviors, data values, patterns, contextual login/location, or other electronic content, occurring within the timeframe(s).

The machine learning model 90 may be trained. The server 26 (or other member 26 of the cloud computing environment 24 illustrated in FIG. 1) may train the machine learning model 90 using one or more entitative batches 110 of the cybersecurity detections 34 representing the false positive cybersecurity detection characteristics 72 associated with the entity 74. The cybersecurity service 30 may receive hundreds or even thousands of weekly cybersecurity detections 34. The cybersecurity service 30 may group the cybersecurity detections 34 according to time, a type of the cybersecurity detection 34, the false positive cybersecurity detection characteristic(s) 72, or other shared, entitative relationship. The cybersecurity service 30, for example, may group the cybersecurity detections 34 according to the user. All the cybersecurity detections 34 that are associated with the same username, for example, may be grouped together for training of, and/or analysis by, the machine learning model 90. The cybersecurity detections 34 that are associated with the same group of users, as another example, may be grouped together for training and/or analysis. The cybersecurity service 30, as more examples, may group the cybersecurity detections 34 according to the same company or employer. The cybersecurity service 30, as still more examples, may group the cybersecurity detections 34 according to the IP address, software process, cloud workload, and/or operating system event. The cybersecurity service 30, as yet more examples, may group the cybersecurity detections 34 according to software vendor/product. The cybersecurity service 30, as a general example, may group or batch the cybersecurity detections 34 according to whatever entity 74 is desired, thus generating the one or more entitative batches 110 of the cybersecurity detections 34. Each cybersecurity detection 34 associated with the corresponding entitative batch 110 may also be associated with the same user/group/company/employer/entity 74. The entitative batch 110 may thus contain a few, or many, false positive cybersecurity detections 20 and/or cybersecurity detections 34 representing one or many false positive cybersecurity detection characteristics 72 associated with the entity 74. The server 26, for example, may train the machine learning model 90 using the entitative batch 110 representing the false positive cybersecurity detection characteristics 72 associated with the entity 74.

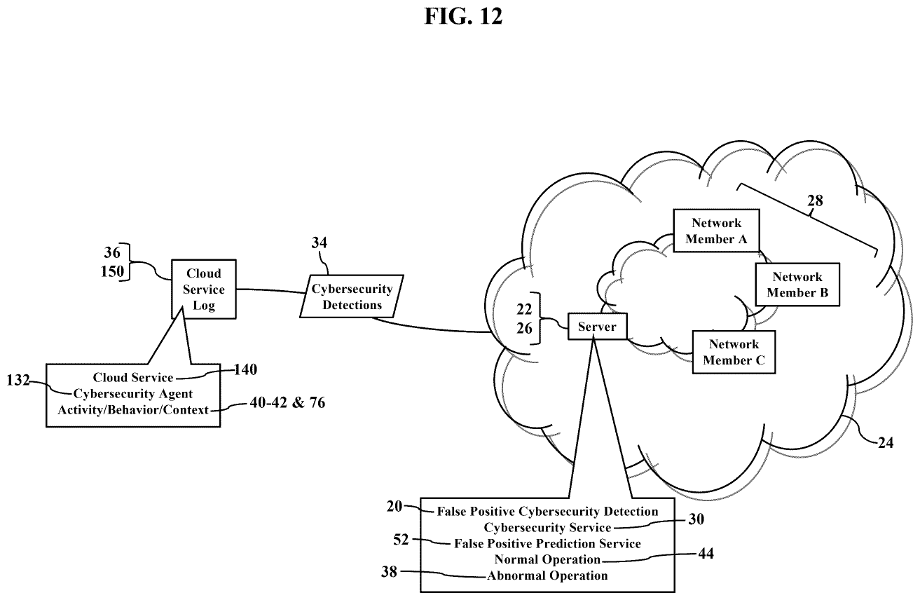

Cloud behavior provides more examples of the entitative batches 110. The cloud computing environment 24 (illustrated in FIG. 1), providing the cybersecurity service 30 and/or the false positive prediction service 52, may retrieve the computer activities/behaviors/contexts 40/42/76 associated with the cybersecurity detection 34. The false positive prediction application 56, for example, may instruct the server 26 to obtain UEBA (User and Entity Behavior Analytics) data and network data associated with the cybersecurity detection 34. These sources for the computer activities/behaviors/contexts 40/42/76, though, may only reveal cybersecurity attacks that started on, or originated from, the client device 36 (such as a user's smartphone or laptop, as illustrated in FIG. 1). However, because the false positive prediction application 56 may obtain the activities/behaviors/contexts 40/42/76 from many other sources (as below discussed), the false positive prediction application 56 may use entitative relationship to obtain far more descriptive activities/behaviors/contexts 40/42/76. The username, IP address, and/or device identifier (e.g., MAC address), for example, may be used to retrieve additional activities/behaviors/contexts 40/42/76 that continue into cloud services (as later discussed with reference to FIG. 12). The false positive prediction application 56 may thus track cybersecurity detections 34, and any associated cyberthreat, in the cloud (such as GOOGLE CLOUD®, MICROSOFT AZURE®, and/or AWS®) by retrieving and tracing cloud entities 74. The false positive prediction application 56, as examples, may use entitative relationships (such as username, IP address, and/or device identifier) to query Amazon's Elastic Container Service Amazon's Elastic Container Registry, and Amazon's Elastic Kubernetes Service. The false positive prediction application 56, as more examples, may query KUBERNETES® workloads (such as pods and daemonsets), clusters (such as collections of KUBERNETES® nodes), and hosts. The false positive prediction application 56, as still more examples, may query public cloud compute instances, such as Amazon's ElasticCompute Cloud.

The false positive cybersecurity detection profile 70 represents the false positive cybersecurity detections 20. As a simple example, the machine learning model 90 may generate the false positive cybersecurity detection profile 70 using Gaussian probability distributions based on false positive training data 112 derived from the false positive cybersecurity detection characteristics 72 associated with the false positive cybersecurity detections 20. One or more standard deviations and confidence intervals may then be calculated to predict the computer activities/behaviors/contexts 40/42/76 that represent the false positive cybersecurity detections 20. As the false positive prediction application 56 inspects the current cybersecurity detection 34, statistical models may be used to predict that the current cybersecurity detection 34 conforms to, matches, or deviates from the false positive cybersecurity detection profile 70.

The false positive prediction service 52 may be unsupervised. If the machine learning model 90 generates the false positive cybersecurity detection profile 70, the false positive prediction service 52 may be autonomously executed within the cloud computing environment 24. The false positive prediction service 52 identifies anomalous computer activities/behaviors/contexts 40/42/76, perhaps according to each entity's false positive cybersecurity detections 20, normal operation 44, and/or abnormal operation 38. The false positive prediction service 52 may extract features representing the false positive cybersecurity detection characteristics 72 and then uses the features as the training data 112 for the machine learning model 90. The false positive prediction service 52, in simple words, identifies the cybersecurity detection(s) 34 that conform to the habitual/historical computer activities/behaviors/contexts 40/42/76 describing the false positive cybersecurity detections 20. The false positive prediction service 52 may also identify the cybersecurity detection(s) 34 that statistically differ from habitual/historical computer activities/behaviors/contexts 40/42/76 describing the false positive cybersecurity detections 20.

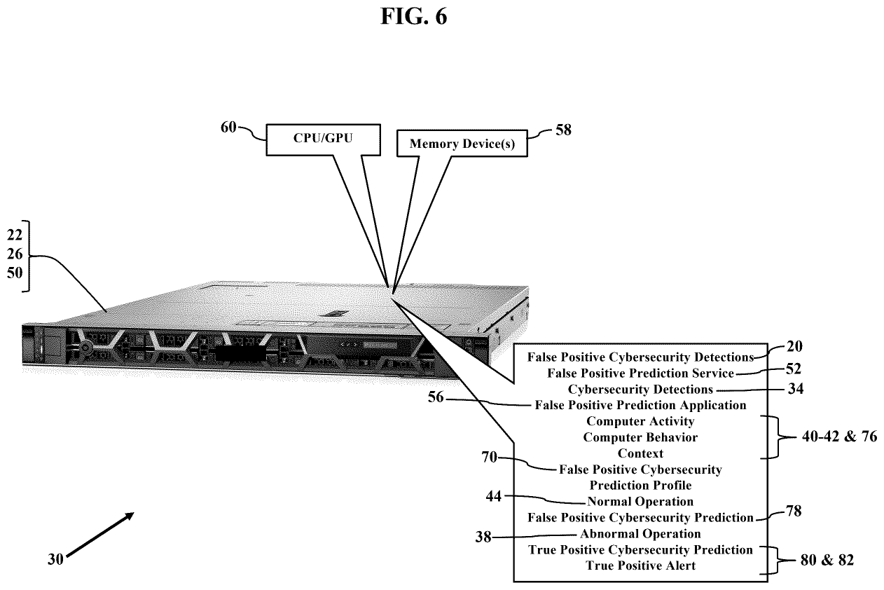

As FIG. 6 illustrates, the server 26 may generate the false positive cybersecurity prediction 78. When the cybersecurity detection 34 conforms to the false positive cybersecurity detection profile 70, the false positive prediction application 56 may thus instruct the server 26 to determine the cybersecurity detection 34 is another false positive cybersecurity detection 20. The server 26 may thus generate the false positive cybersecurity prediction 78 as an output, and the false positive cybersecurity prediction 78 determines, or predicts, that the cybersecurity detection 34 is the safe or normal operation 44. In simple words, because the cybersecurity detection 34 (e.g., the computer activities/behaviors/contexts 40/42/76) sufficiently matches some historical or contemporaneous measures of the false positive cybersecurity detections 20, the cybersecurity detection 34 is classified as the safe or normal operation 44. The cybersecurity detection 34 may further be labeled, sorted, or classified as the false positive cybersecurity detection 20. The cybersecurity detection 34 is thus benign, low priority, and/or not requiring of further investigation.

The server 26, however, may predict the abnormal operation 38. When the cybersecurity detection 34 fails to conform to the false positive cybersecurity detection profile 70, then the false positive prediction application 56 may determine that the cybersecurity detection 34 is the abnormal operation 38. The current cybersecurity detection 34, for example, may represent unknown computer activities/behaviors/contexts 40/42/76 not historically logged or observed. The current cybersecurity detection 34, as another example, may represent computer activities/behaviors/contexts 40/42/76 that statistically lie outside the false positive cybersecurity detection profile 70. Any mismatch or deviation from the false positive cybersecurity detection profile 70 may determine the abnormal operation 38. Because the cybersecurity detection 34 fails to conform to the false positive cybersecurity detection profile 70, the false positive prediction application 56 may further label or categorize the cybersecurity detection 34 as the true positive cybersecurity detection 80. The false positive prediction application 56 may generate and send the true positive alert 82 indicating the cybersecurity detection 34 represents the abnormal operation 38. The false positive prediction service 52 may thus queue the cybersecurity detection 34 for a more in-depth analysis and perhaps even human review.

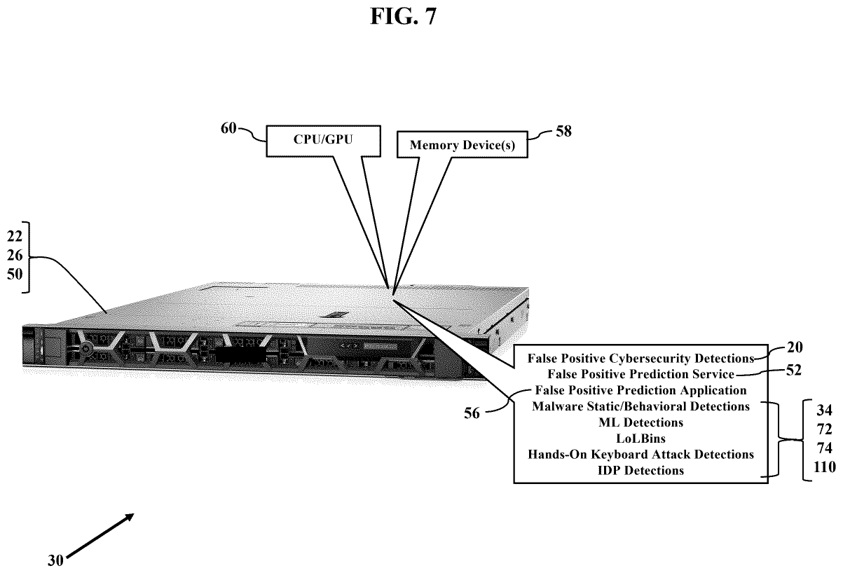

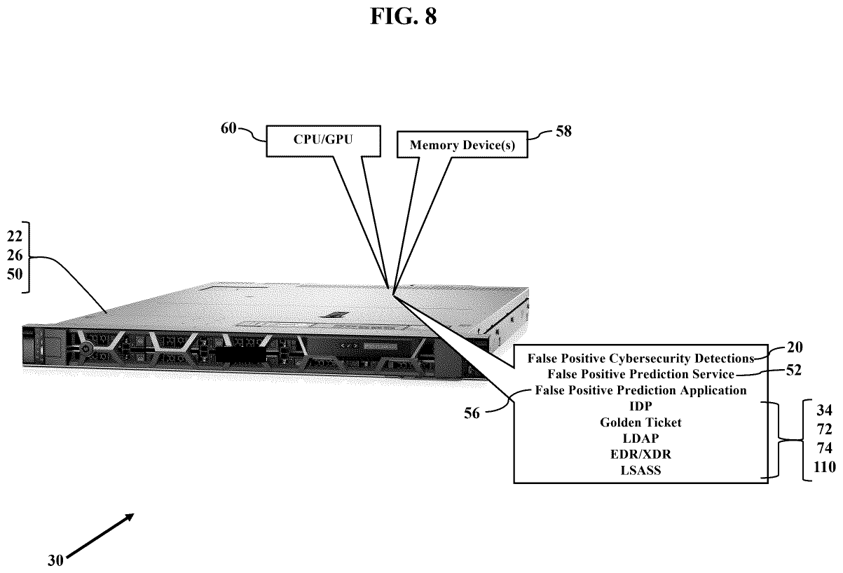

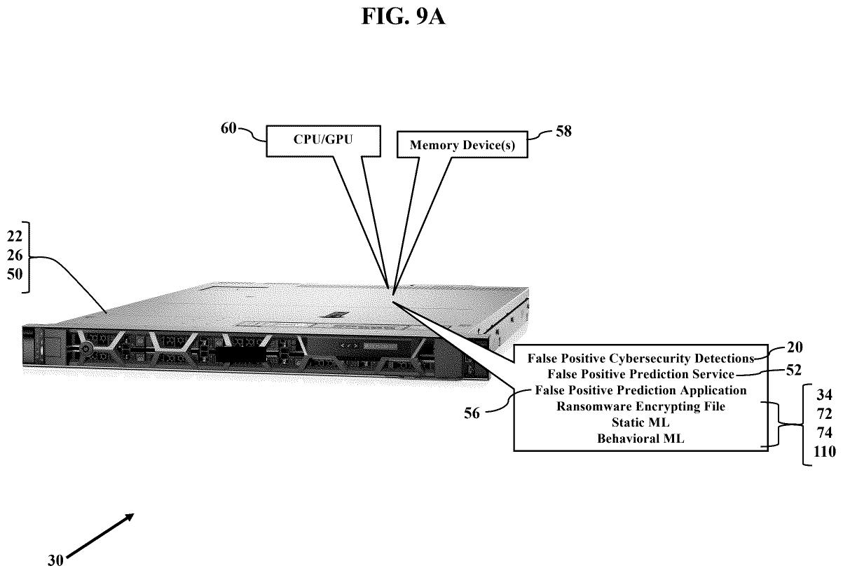

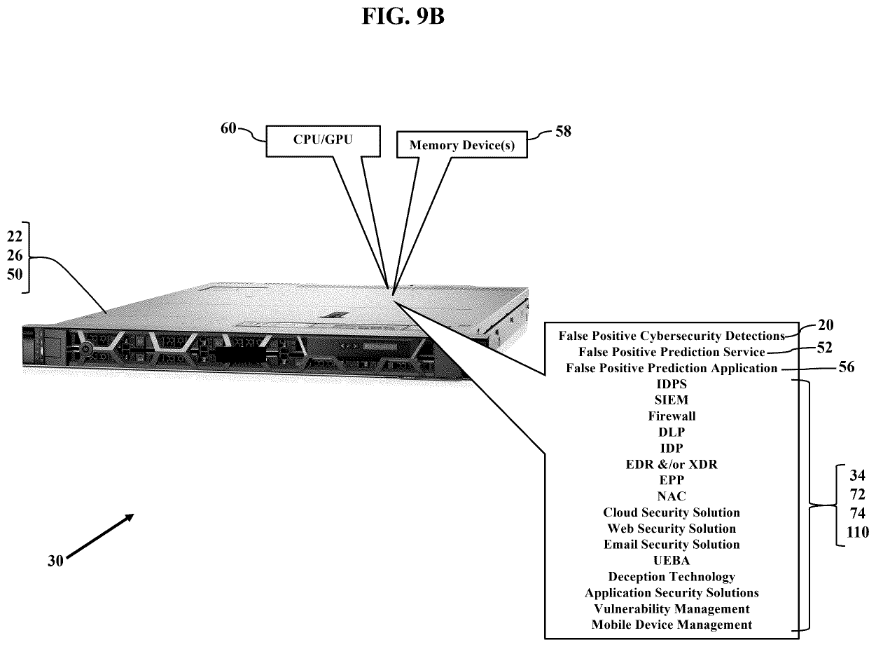

FIGS. 7-8 and 9A-9B illustrate more examples of entitative batching. Because the cybersecurity service 30 may receive many cybersecurity detections 34, the cybersecurity service 30 may group and/or subgroup the cybersecurity detections 34 for refined predictions. The cybersecurity service 30, for example, may group the cybersecurity detections 34 according to the entity 74, thus generating the corresponding entitative batch 110. The cybersecurity detections 34, as examples, may be grouped by detection type and/or by entity type (such as IDP detections, static machine learning (or ML) detections, and behavioral ML detections). The cybersecurity detections 34, as more examples, may be grouped by user, customer, product, or company source/type. Moreover, the cybersecurity service 30 may further subgroup the cybersecurity detections 34 within the entitative batch 110. FIG. 7, as examples, illustrates the cybersecurity detections 34 grouped according to malware static/behavioral detections, ML detections, Living off the land binaries (or Lolbins), Hands-on Keyboard attack detections, and IDP detections. FIG. 8, as more examples, illustrates the cybersecurity detections 34 grouped according to the identity provider (or IDP), such as Golden Ticket Attack (e.g., using a golden ticket to request access and/or detecting abusive KERBEROS® protocol usage), IDP LDAP Reconnaissance Account Discovery (e.g., a user executed a suspicious LDAP search enumerating AD accounts and/or cases where user executed a suspicious LDAP search request commonly performed by known reconnaissance attack tools, such as Bloodhound or Impacket), and EDR/XDR detections 34 (such as mimikatz hack tool detection, which detects the Local Security Authority Subsystem Service (or LSASS) process that was accessed from the mimikatz hack tool, such as by opening a handle to LSASS for credential dumping). FIG. 9A, as still more examples, illustrates the cybersecurity detections 34 grouped according to the Ransomware Encrypting File detection (e.g., detecting a file with a known ransomware extension), static ML detection (e.g., machine learning detection with high-confidence results), behavioral ML detection (e.g., detection of a process that launched and meets a behavioral ML algorithm's high confidence threshold). By entitatively batching the cybersecurity detections 34, each entitative batch 110 may reveal finer and more accurate false positive cybersecurity detection characteristics 72. The entitative batching may thus result in more accurate profiling (such as extracted features for training of the machine learning model 90 as illustrated in FIGS. 4-5).

FIG. 9B illustrates even more examples of entitative batching. The cybersecurity service 30 may group and/or subgroup the cybersecurity detections 34 according to even more categories of the entitative batches 110. A first category, for example, may include Intrusion Detection and Prevention Systems (or IDPS). These products and/or services include Network Intrusion Detection Systems (or NIDS), Host Intrusion Detection Systems (or HIDS), Intrusion Prevention Systems (or IPS), Unified Threat Management (or UTM), Next-Generation Intrusion Prevention Systems (or NGIPS), and many others. These products and/or services may generate/send/report the cybersecurity detections 34, such as signature-based detections, anomaly-based detections, protocol anomaly detections, zero-day exploit detections, network-based attacks (e.g., port scans, brute force attacks), host-based attacks (e.g., privilege escalation), Denial of Service (or DoS) attacks, backdoor detections, buffer overflow attacks, and SQL injection attacks.

The cybersecurity service 30 may group according to Security Information and Event Management (or SIEM). These products and/or services include traditional SIEM systems, Next-Generation SIEM (NG SIEM), cloud-based SIEM, managed SIEM services, and SIEM with user and entity behavior analytics (or UEBA) integration. These products and/or services may generate/send/report the cybersecurity detections 34, such as anomalous network traffic, insider threats, behavioral analytics, advanced threat detection, and compliance monitoring.

The cybersecurity service 30 may group according to firewall(s). These products and/or services include traditional network firewalls, Next-Generation Firewalls (or NGFW), Web Application Firewalls (or WAF), cloud firewalls, and Unified Threat Management (or UTM) Firewalls. These products and/or services may generate/send/report the cybersecurity detections 34, such as port scanning detections, intrusion detection/prevention, unusual protocol usage detections, IP spoofing, DDoS attacks, malicious payloads, outbound traffic anomalies, application layer attacks, and VPN exploits.

The cybersecurity service 30 may group according to Data Loss Prevention (or DLP). These products and/or services include endpoint DLP solutions, network DLP solutions, cloud DLP solutions, email DLP solutions, and integrated DLP platforms. These products and/or services may generate/send/report the cybersecurity detections 34, such as sensitive data transfer detections, email leakage, endpoint data leakage, cloud data protection, file sharing monitoring, removable media control, data masking and encryption violations, and database activity monitoring.

The cybersecurity service 30 may group according to Identity Detection and Protection (or IDP). These products and/or services include Identity and Access Management (or IAM) Systems, Multi-Factor Authentication (or MFA) Solutions, Privileged Access Management (or PAM), Single Sign-On (or SSO) Solutions, and Identity Governance and Administration (or IGA). These products and/or services may generate/send/report the cybersecurity detections 34, such as the Golden ticket attacks, LDAP reconnaissance, Pass-the-Hash (or PtH) attacks, password spraying, brute force attacks, privileged account abuse, account hijacking, user behavior anomalies, single sign-on (or SSO) abuse, and multi-factor authentication (MFA) bypass.

The cybersecurity service 30 may group according to Endpoint Detection and Response (or EDR) and Extended Detection and Response (or XDR). These products and/or services include EDR platforms, XDR solutions, Endpoint Protection Platforms (or EPP), and Next-Generation Antivirus (or NGAV). These products and/or services may generate/send/report the cybersecurity detections 34, such as ransomware, fileless malware, advanced persistent threats (or APTs), credential dumping, lateral movement, persistence mechanisms, data exfiltration, command and control (or C2) communication, privilege escalation, parasitic viruses, coin miners, backdoors, and trojans/downloaders.

The cybersecurity service 30 may group according to the Endpoint Protection Platform (or EPP). These products and/or services include antivirus software, antimalware solutions, exploit prevention tools, application whitelist/blacklist, and Host Intrusion Prevention Systems (or HIPS). These products and/or services may generate/send/report the cybersecurity detections 34, such as antivirus/malware detections, behavioral analysis, exploit prevention, file integrity monitoring, application whitelisting/blocking, script control detections, and web based threats.

The cybersecurity service 30 may group according to Network Access Control (or NAC). These products and/or services include network admission control, endpoint compliance checking, guest access management, IoT security solutions, and other bring-your-own-device (or BYOD) management solutions. These products and/or services may generate/send/report the cybersecurity detections 34, such as unauthorized device detections, endpoint compliance checks, network segmentation, guest access monitoring, BYOD management, IoT device monitoring, anomalous network access, policy violations, quarantine management, and access control list (or ACL) alerts.

The cybersecurity service 30 may group according to the cloud security solution. These products and/or services include Cloud Access Security Brokers (or CASBs), Cloud Security Posture Management (or CSPM), Cloud Workload Protection Platforms (or CWPP), Cloud Infrastructure Entitlement Management (or CIEM), and Cloud-Native Security Platforms (or CNSP). These products and/or services may generate/send/report the cybersecurity detections 34, such as unauthorized data transfers to/from cloud services, monitoring and securing data in cloud storage, compliance with cloud configurations, protecting cloud workloads, cloud entitlements and permissions, shadow IT detection, cloud service misconfigurations, malicious cloud activity detection, API abuse detection, and data residency violations.

The cybersecurity service 30 may group according to the web security solution. These products and/or services include Secure Web Gateways (or SWG), URL filtering systems, content filtering systems, web application security platforms, and secure socket layer (or SSL) inspection tools. These products and/or services may generate/send/report the cybersecurity detections 34, such as malicious website access, URL filtering, content filtering, web-based threats, script injection, browser exploitation, phishing websites, drive-by downloads, inappropriate content access, and SSL inspection.

The cybersecurity service 30 may group according to the email security solution. These products and/or services include email security gateways, anti-spam filters, phishing detection systems, email encryption solutions, and email threat protection platforms. These products and/or services may generate/send/report the cybersecurity detections 34, such as phishing emails, spam detection, malware attachments, email spoofing, data leakage through email, business email compromise (or BEC), malicious links, impersonation attacks, email account takeover, and advanced persistent threats (or APTs) via email.

The cybersecurity service 30 may group according to the User and Entity Behavior Analytics (or UEBA). These products and/or services include email behavioral analytics platforms, anomaly detection systems, insider threat detection solutions, user activity monitoring tools, and entity behavior profiling systems. These products and/or services may generate/send/report the cybersecurity detections 34, such as user behavior anomalies, entity behavior analysis, insider threats, account compromise detection, unusual access patterns, privilege abuse, lateral movement detection, data exfiltration activities, suspicious login attempts, and abnormal file access.

The cybersecurity service 30 may group according to deception technology. These products and/or services include honeypots, honeytokens, deception platforms, decoy systems, and deception grids. These products and/or services may generate/send/report the cybersecurity detections 34, such as unauthorized access to decoys, interaction with honeytokens, lateral movement detection, credential theft attempts, malicious reconnaissance, fake service interactions, decoy network communications, suspicious activity in decoy environments, anomalous user behavior on decoys, and exploitation attempts on decoy systems.

The cybersecurity service 30 may group according to the application security solution. These products and/or services include Static Application Security Testing (SAST), Dynamic Application Security Testing (DAST), Runtime Application Self-Protection (RASP), Interactive Application Security Testing (IAST), and Application Vulnerability Scanners. These products and/or services may generate/send/report the cybersecurity detections 34, such as code vulnerabilities, runtime exploits, application attacks, input validation failures, security misconfigurations, SQL injection attacks, cross-site scripting (XSS), insecure API usage, authentication bypass, and session hijacking.

The cybersecurity service 30 may group according to vulnerability management. These products and/or services include vulnerability scanners, Patch Management Systems, Configuration Management Tools, Compliance Management Systems, and Penetration Testing Tools. These products and/or services may generate/send/report the cybersecurity detections 34, such as vulnerability detection, unpatched software, security misconfigurations, compliance violations, weak password policies, outdated software, open ports, insecure configurations, unprotected sensitive data, and end-of-life software checks.

The cybersecurity service 30 may group according to Mobile Device Management (or MDM). These products and/or services include Mobile Security Solutions, Mobile Threat Defense (MTD), Mobile Application Management (MAM), Mobile Content Management (MCM), and Unified Endpoint Management (UEM). These products and/or services may generate/send/report the cybersecurity detections 34, such as mobile malware, unauthorized mobile access, data leakage from mobile devices, compliance with mobile policies, rooted/jailbroken devices, malicious mobile applications, device location tracking, mobile phishing attempts, insecure mobile configurations, and network attacks targeting mobile devices.

Computer functioning is greatly improved. Conventional anomaly-detection schemes attempt to reduce false positives by improving rules-based, or machine-learned based, anomaly detections. Rules-based approaches cannot contextualize normal verses abnormal behavior for each individual user/device/entity. The conventional anomaly-detection schemes focus on single event-level information, which is very inaccurate and results in high false-positive rates. The false positive prediction service 52, instead, causes the computer system 22 (such as the server 26) to monitor and profile the false positive cybersecurity detections 20. The computer system 22 aggregates the false positive cybersecurity detection characteristics 72, perhaps according to different entitative batches 110 of the cybersecurity detections 34. The computer system 22, and/or the cloud computing environment 24, may use the machine learning model 90 to generate the false positive cybersecurity detection profile 70 and to predict the false positive cybersecurity detections 20. The computer system 22 thus more accurately identifies each entity's false positive computer activities/behaviors/contexts 40/42/76 and/or the false positive cybersecurity detection characteristics 72. The computer system 22 more accurately identifies the normal operation 44. The computer system 22 also more accurately identifies the abnormal operation 38, meaning malicious usage is more quickly identified and resolved. The computer system 22 protects client devices, cloud services, and/or the cloud computing environment 24 from cyber threats.

Computer functioning is further improved. The false positive cybersecurity detections 20 greatly waste resources (as previously explained). The false positive prediction service 52, though, greatly reduces and conserves hardware (e.g., processor and memory) and network resources. By predicting the false positive cybersecurity detections 20, processor cycles are reduced/eliminated and much memory bytes are conserved. Network packet traffic is greatly reduced, as the predicted false positive cybersecurity detections 20 may be immediately/initially dropped from further analysis. Indeed, as the false positive prediction service 52 may predict over half of the cybersecurity detections 34 are false positives, substantial resources may be reduced and reallocated. Substantial electrical power is concomitantly conserved.

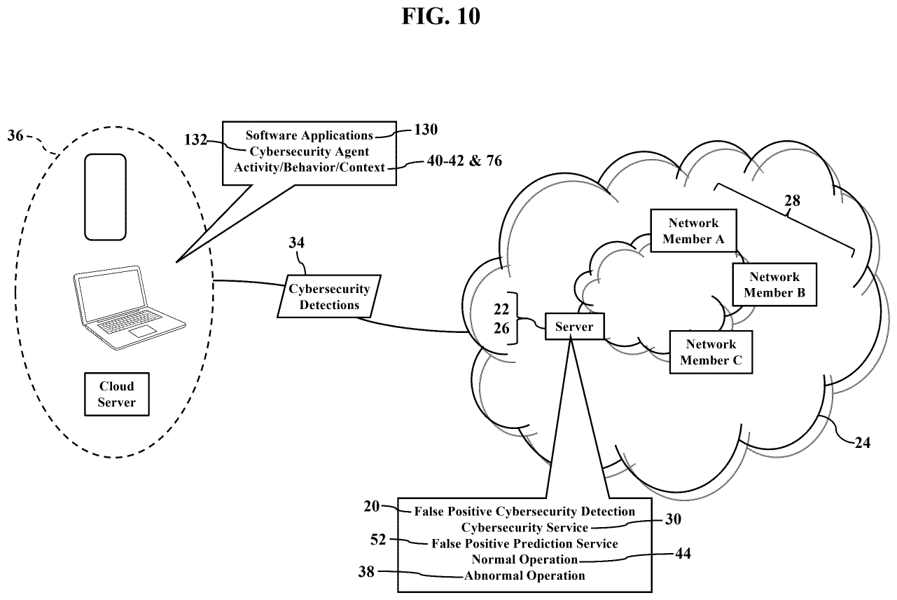

FIGS. 10-12 illustrate examples of detection sourcing. The computer system 22 (again illustrated as the server 26) receives the cybersecurity detection 34. While the cybersecurity detection 34 may be sent or retrieved from the cloud computing network 24, the cybersecurity detection 34 may originate from the client device 36 (perhaps subscribing to the cybersecurity service 30 and/or the false positive prediction service 52). The client device 36 has a hardware processor that executes an operating system stored in a local memory device (all not shown for simplicity). The client device 36 stores many software applications 130 that are executed by its hardware processor. Some of the software applications 130, for example, represent an endpoint cybersecurity agent 132. The endpoint cybersecurity agent 132 has instructions or code that interface with the client's operating system and/or with the software applications 130. The endpoint cybersecurity agent 132 thus senses and monitors events, operations, processes, and other computer activities/behaviors/contexts 40/42/76 conducted by the client device 36. As the client device's hardware processor executes the software applications 130, any of the software applications 130 may attempt to maliciously affect the client device 36. When the endpoint cybersecurity agent 132 detects suspicious or unknown computer activities/behaviors/contexts 40/42/76, the endpoint cybersecurity agent 132 generates and sends the cybersecurity detection 34 via a communications network (not shown for simplicity) to an IP address associated with the cybersecurity service 30. When the cloud computing environment 24 receives the cybersecurity detection 34, the networked members 28 of the cloud computing environment 24 may route the cybersecurity detection 34 to the server 26 for the fast and elegant false positive prediction service 52. If the false positive cybersecurity detection 20 is predicted, then perhaps the endpoint cybersecurity agent 132 is authorized to approve/allow the computer activities/behaviors/contexts 40/42/76. If, however, the abnormal operation 38 is predicted, the cloud computing environment 24 may instruct the endpoint cybersecurity agent 132 to deny or terminate the computer activities/behaviors/contexts 40/42/76. The cloud computing environment 24 and/or the endpoint cybersecurity agent 132 may also cause the software application(s) 130 to terminate.

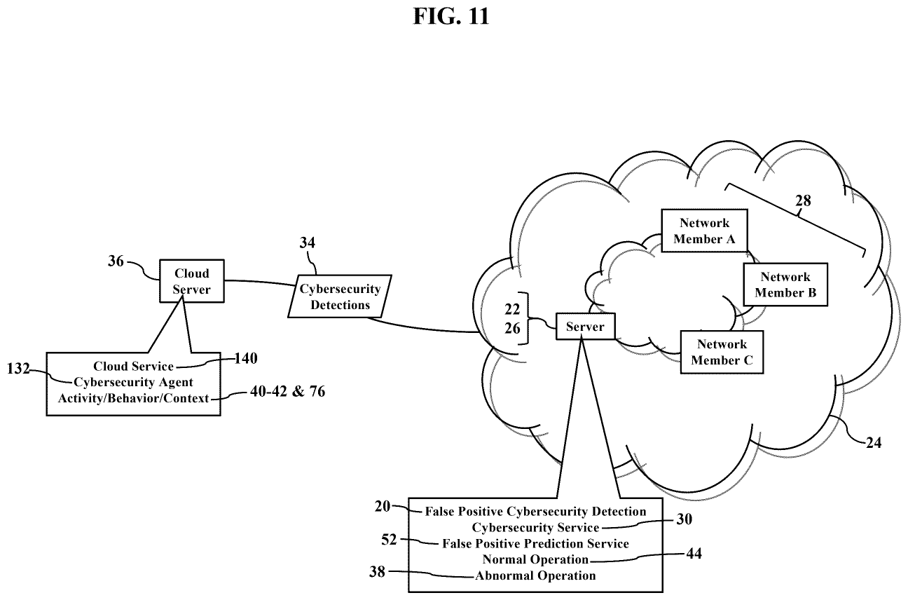

FIG. 11 illustrates examples of cloud sourcing. Here the endpoint cybersecurity agent 132 may monitor a cloud service 140 for suspicious/unknown computer activities/behaviors/contexts 40/42/76. The cloud service 140 is provided on behalf of a cloud service provider. There are many different cloud services 140, such as word processing, cloud storage, email, cybersecurity, social networking, video conferencing, entertainment, shopping, and banking. There are also many different cloud service providers, such as APPLE®, GOOGLE®, MICROSOFT®, AMAZON® NETFLIX®, ZOOM®, FACEBOOK®, and UBER®. The endpoint cybersecurity agent 132 may thus be installed to any cloud server as the client device 26 providing at least a portion of the cloud service 140. The endpoint cybersecurity agent 132 monitors events, operations, processes, and other computer activities/behaviors/contexts 40/42/76 associated with the cloud service 140. When the endpoint cybersecurity agent 132 detects suspicious/unknown computer activities/behaviors/contexts 40/42/76, the endpoint cybersecurity agent 132 generates and sends the cybersecurity detection 34 to an IP or other network address associated with the cybersecurity service 30. When the cloud computing environment 24 receives the cybersecurity detection 34, the cloud computing environment 24 may route the cybersecurity detection 34 to the server 26 for the false positive prediction service 52. The server 26 may thus receive the cybersecurity detection 34 as a real time, or near real time, monitoring input. If the normal operation 44 (and/or the false positive cybersecurity detection 20) is predicted, then perhaps the endpoint cybersecurity agent 132 is authorized to approve/allow the computer activities/behaviors/contexts 40/42/76. If, however, the abnormal operation 38 is predicted, the cloud computing environment 24 may hand-off the cybersecurity detection 34 to other systems, teams, groups, and/or networked members 28 for a deeper or more sophisticated analysis. The false positive prediction service 52 may have authority to delay the cloud service 140 pending further investigation. The false positive prediction service 52 may have authority to instruct the endpoint cybersecurity agent 132 to deny or terminate the computer activities/behaviors/contexts 40/42/76, and/or the cloud service 140, again perhaps in real time or near real time. The false positive prediction service 52 thus monitors the cloud service 140 and detects false and true positive computer activities/behaviors/contexts 40/42/76 representing a potential cybersecurity threat or attack.

As FIG. 12 illustrates, the false positive prediction service 52 may also interface with cloud logging services. As the cloud service 140 is provided, the cloud service 140 may log and store events associated with the cloud service 140. While other data logging schemes may be used, FIG. 12 illustrates a cloud service log 150. The cloud service log 150 may be a cloud/network database resource that stores service/computer activities/behaviors/contexts 40/42/76 and their corresponding time stamps. The cloud service 140 may thus make the cloud service log 150 available to third parties (such as the cybersecurity service 30 and/or to the false positive prediction service 52). The false positive prediction service 52 may thus interface with the cloud service log 150. The server 26, for example, may query the cloud service log 150 and to retrieve any data logs associated with the cybersecurity detection 34 (again perhaps logged within a window of time). By retrieving the data logs, for example, the false positive prediction service 52 may identify and retrieve a fuller description of the computer activities/behaviors/contexts 40/42/76 surrounding or occurring over any timeframe of the cybersecurity detection 34.

The cloud service log 150 may thus supplement the training data 112. As this disclosure above explained, the false positive prediction service 52 extracts features that represent the false positive cybersecurity detections 20 (such as the false positive cybersecurity detection characteristics 72). While the false positive cybersecurity detection characteristics 72 may be retrieved from any network source or service, the false positive cybersecurity detection characteristics 72 may be retrieved from the cloud service log 150. While other cloud logging services may be used, Amazon's AWS CLOUDTRAIL® service logs actions taken by client devices and any AWS cloud service 140. The AWS CLOUDTRAIL® data, in other words, may be one of the sources for the false positive cybersecurity detection characteristics 72. Whatever the cloud logging service, though, log data often reveals the false positive cybersecurity detection characteristics 72 (such as usage patterns, roles, responsibilities, intentions, and context).

The cloud service provider may rely on the false positive prediction service 52. When the cloud service 140 is provided, the cloud service provider needs tools that identify the unusual or abnormal operation 38. Anomalous cloud behavior is often a precursor to identifying malicious behavior and cybersecurity threats/attacks. The false positive prediction service 52 identifies the false positive cybersecurity detections 20 generated while providing the cloud service 140. Conventional cybersecurity schemes strive to detect abnormal computer activity, so these conventional cybersecurity schemes generate enormous numbers of false positive reports of malicious behavior. The false positive prediction service 52, in contradistinction, more accurately defines the false positive cybersecurity detections 20 and their normal operation 44. Because each user's, and each service's, cloud behavior may be unique and variable, the false positive prediction service 52 learns from the usage patterns and behavior represented by previous/historical/current false positive cybersecurity detections 20. The false positive prediction service 52 captures the more expansive and richer false positive cybersecurity detection characteristics 72 reflected by the false positive cybersecurity detections 20.

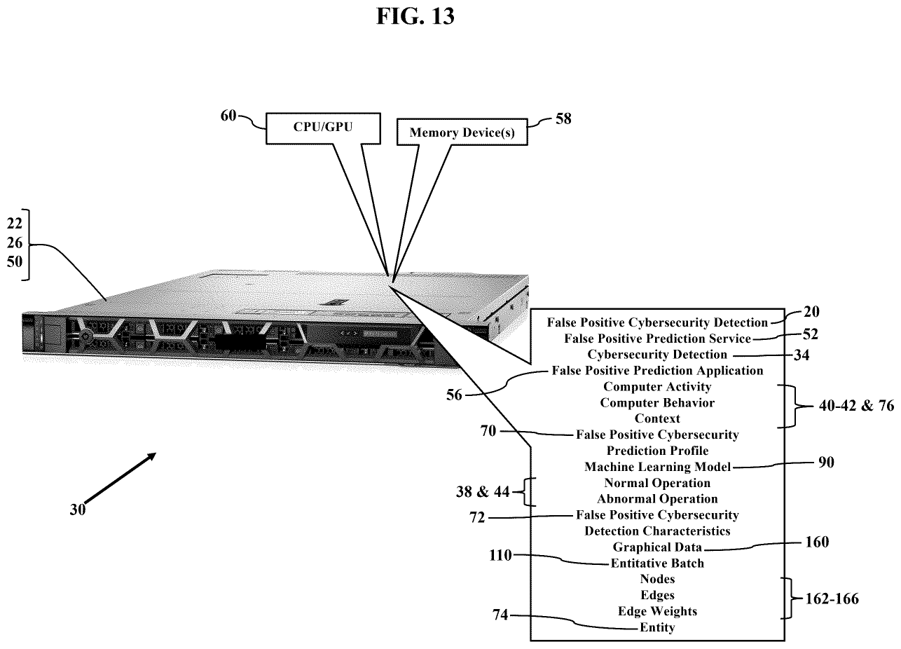

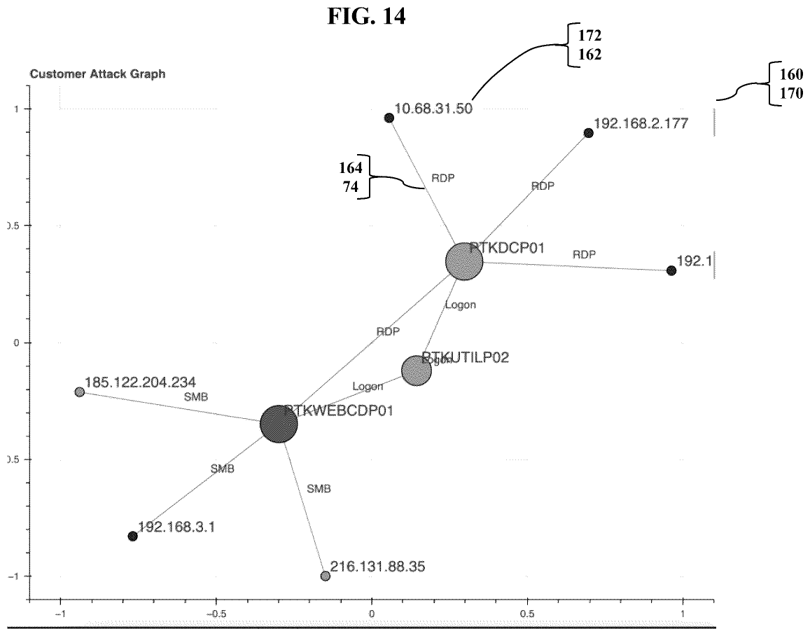

FIGS. 13-14 illustrate more examples of predicting the false positive cybersecurity detections 20. When the server 26 (again illustrated as the rack server 50) receives the cybersecurity detection 34, the server 26 executes the false positive prediction application 56 as the predictor engine. The server 26 may ingest the cybersecurity detection 34 (and/or its associated computer activities/behaviors/contexts 40/42/76) as an input, and the false positive prediction application 56 instructs the server 26 to compare the cybersecurity detection 34 to the false positive cybersecurity detection profile 70. The false positive cybersecurity detection profile 70 may be generated by the machine learning model 90. The server 26 may thus execute the machine learning model 90 to build the false positive cybersecurity detection profile 70. The machine learning model 90 generates the false positive cybersecurity detection profile 70 to statistically identify (e.g., ±3σ standard deviations) the safe or normal operation 44. Because the machine learning model 90 builds the false positive cybersecurity detection profile 70, the machine learning model 90 may statistically predict a range of the safe or normal operation 44, in terms of past/historical/habitual/current false positive cybersecurity detection characteristics 72.

The machine learning model 90 may be trained using graphical data 160. The graphical data 160 represents the entitative batch(es) 110 of the cybersecurity detections 34. The graphical data 160 has nodes 162 and edges 164, and the edges 164 may be weighted with edge weights 166 representing the false positive cybersecurity detection characteristics 72 associated with the entity 74. The false positive prediction service 52 (such as the server 26) may train the machine learning model 90 using the graphical data 160 representing the entitative batch 110 of the cybersecurity detections 34, with the graphical edges 164 weighted with the edge weights 166 representing the false positive cybersecurity detection characteristics 72 associated with the entity 74.

The edge weights 166, for example, may represent a detection frequency. The cybersecurity service 30 may analyze how frequently each cybersecurity detection 34 occurs across one or multiple entities 74 (such as, for example, different devices, different software processes, and/or different users/groups). If the cybersecurity detection 34 frequently occurs across many entities 74 in a consistent pattern, for example, this pattern may indicate a strong relationship between those entities 74. For example, if the software process svchost.exe is frequently detected as suspicious across multiple devices (e.g., Device-1, Device-2, Device-3), the edges 164 connecting these devices to svchost.exe may be assigned higher edge weights 166.

The edge weights 166, as more examples, may represent time decay factors. The edge weights 166 may be adjusted by incorporating a time decay factor that gives more importance to recent cybersecurity detections 34. The time decay factor ensures that the graphical data 160 reflects the most current and relevant data. For example, a cybersecurity detection 34 that occurred recently might be weighted more heavily than a historical cybersecurity detection 34 that occurred several weeks ago, making the edge 164 more significant in the current context.

The edge weights 166, as still more examples, may represent batch statistics. The cybersecurity service 30, for example, may group or batch the cybersecurity detections 34 based on relationships (e.g., all detections related to a specific user or device within a time frame, as explained with reference to FIGS. 5-9B). Statistical analysis is then performed to identify commonalities and outliers. The edge 164 for each cybersecurity detection 34 may be derived from this statistical analysis, where cybersecurity detections 34 that show consistent patterns within the entitative batch 110 receive higher edge weights 166. For example, if several devices in the same network segment show similar detection patterns over time, the edges 164 between these devices and the associated detections 34 are weighted more heavily.

The edge weights 166, as yet more examples, may represent intra/inter-batching. The edge weights 166 may be assigned differently depending on whether the entitative relationship is within the same batch 110 (i.e., intra-batch) or across different batches 110 (i.e., inter-batch). Intra-batch edges 164 might have a higher edge weight 166 if the detections 24 within the batch 110 are highly correlated. For example, if Process-A and Process-B are both frequently detected on the same set of devices within a short time window, the edge 164 between them in the graph will have a higher edge weight 166.

The cybersecurity service 30 may adjust the edge weights 166 during prediction and during operation. The edge weights 166, for example, may be dynamically adjusted in real-time as new data comes in. The edge weights 166, as another example, may be dynamically adjusted based on historical data (such as the previous hours/days). The edge weights 166 may thus reflect the current state, or an historical state, of the cybersecurity system 30. For example, as new detections 24 occur, the cybersecurity system 30 may update the graphical data 160 with the most recent information. The frequency and timing of these new detections 34 may influence the edge weights 166. If a detection pattern that was observed during training suddenly spikes in frequency, for example, the associated edges weights 166 are increased. For example, if svchost.exe suddenly start exhibiting unusual behavior across multiple devices, the edges 164 connecting these devices to svchost.exe are assigned higher edges weights 166.

The cybersecurity service 30, as more examples, may adjust the edge weights 166 based on the activity/behavior/context 40/42/76. If, for example, a detection 34 deviates significantly from the normal operation 44 learned during training, this deviation could indicate an anomaly. The edge weights 166 may be adjusted accordingly to reflect the increased importance of this relationship in identifying potential false positives or true positives. For example, if a normally benign process suddenly triggers new detection 24 (alert), the edge 164 between this process and the detection node may be assigned a higher edges weight 166.

The edge weights 166, as more examples, may represent the activity/behavior/context 40/42/76. The cybersecurity service 30 integrate current and/or historical activity/behavior/context 40/42/76 to refine the edge weights 166. For example, if a process has a known history of triggering false positives in specific contexts 76, the edge weights 166 may be adjusted down to reduce the likelihood of FPs. For example, if Process-C has a history of benign behavior when triggered by User-A, the edge weight 166 between Process-C and detections related to User-A might be reduced.

Also, instead of adding a new node for a detection group, the cybersecurity service 30 may create direct edges 164 between all detection nodes within that group, with the edge weights 166 reflecting their relationship (e.g., frequency, similarity). For example, if Detection-1, Detection-2, and Detection-3 all occur in the same batch 110, the edges 164 may be drawn directly between them with the edge weights 166 proportional to their similarity and frequency. This could help minimize number of additional nodes (which means simpler and more interpretable graph structure).

The edge weights 166 may be calculated to suit the use. The edge weights 166, for examples, may be determined using frequency. Assume, for example, three (3) devices (Device-A, Device-B, Device-C) and two (2) processes (Process-X, Process-Y). The processes have been detected on these devices with the following frequencies over the last 30 days:
Process-X on Device-A: 20 times;
Process-X on Device-B: 15 times;
Process-X on Device-C: 25 times;
Process-Y on Device-A: 10 times;
Process-Y on Device-B: 5 times; and
Process-Y on Device-C: 30 times.
   The cybersecurity service 30 may normalize the frequency counts so that they can be used as the edge weights 166. Assume, for example, that the cybersecurity service 30 normalizes the counts by the maximum frequency observed (30 in this case):

$$Weight for Device - A and Process - X = 20 / 30 = 0.67 ;$$

$$Weight for Device - B and Process - X = 15 / 30 = 0.5 ;$$

$$Weight for Device - C and Process - X = 25 / 30 = 0.83 ;$$

$$Weight for Device - A and Process - Y = 10 / 30 = 0.33 ;$$

$$Weight for Device - B and Process - Y = 5 / 30 = 0.17 ; and$$

$$Weight for Device - C and Process - Y = 30 / 30 = 1. .$$

These edge weights 166 may thus indicate the strength of the relationship between each device and process. For instance, Device-C and Process-Y have the highest edge weight (1.00), suggesting a strong relationship, likely due to the high frequency of detection.

Another example of frequency-based edge weights 166 is provided. Suppose there are three (3) detections 24 (Detection-1, Detection-2, Detection-3) occurring across 4 devices (Device-E, Device-F, Device-G, Device-H) within the same time frame:
Detection-1 is seen on Device-E and Device-F,
   Detection-2 is seen on Device-G, and
Detection-3 is seen on Device-H and Device-E.
   The cybersecurity service 30 may group the detections 34 into the batches 110 based on their occurrence within the same time frame. For Batch 1 {Detection-1, Detection-2, Detection-3}, the cybersecurity service 30 may calculate the frequency of each detection 34 in the batch 110:

$$Frequency of Detection - 1 in Batch 1 = 2 ( seen on 2 devices ) ;$$

$$Frequency of Detection - 1 in Batch 1 = 2 ( seen on 2 devices ) ;$$

$$Frequency of Detection - 2 in Batch 1 = 1 ( seen on 1 device ) ;$$

$$Frequency of Detection - 2 in Batch 1 = 1 ( seen on 1 device ) ;$$

$$Frequency of Detection - 3 in Batch 1 = 2 ( seen on 2 devices ) ; and$$

$$Frequency of Detection - 3 in Batch 1 = 2 ( seen on 2 devices ) .$$

The cybersecurity service 30 may calculate the edge weights 166 based on these frequencies, normalized by the total number of devices in the batch 110:

$$Edge Weight for Device - E and Detection - 1 = 2 / 4 = 0.5$$

$$Edge Weight for Device - F and Detection - 1 = 2 / 4 = 0.25$$

$$Edge Weight for Device - G and Detection - 2 = 1 / 4 = 0.25$$

$$Edge Weight for Device - H and Detection - 3 = 2 / 4 = 0.5$$

These edge weights 166 indicate the strength of the relationship between devices 36 and detections 34 within this batch 110, with higher weights 166 for more frequent occurrences.

The false positive cybersecurity detection profile 70 may again represent a richer description of the safe or normal operation 44. Because the false positive cybersecurity detection profile 70 is generated using the graphical data 160, the false positive prediction service 52 more accurately predicts the normal operation 44 and the false positive cybersecurity detections 20. When the cybersecurity detection 34 conforms to the false positive cybersecurity detection profile 70, the false positive prediction application 56 may thus instruct the server 26 to generate the false positive cybersecurity prediction 78. When the cybersecurity detection 34, however, fails to conform to the false positive cybersecurity detection profile 70, then the false positive prediction application 56 may determine that the cybersecurity detection 34 is the abnormal operation 38. The cybersecurity detection 34 may thus be routed to other systems for a more in-depth analysis and perhaps even human review.

FIG. 14 illustrates examples of the graphical data 160. FIG. 14 visually represents the graphical data 160 as a two-dimensional attack graph 170. While the attack graph 170 may plot many different data sets, FIG. 14 illustrate the attack graph 170 plotting IP addresses 172 as the nodes 162. Each IP address 172 may be associated with its corresponding endpoint cybersecurity agent 132 monitoring its host client device 36 (such as an agent identifier, not shown for simplicity). Each edge 164 connects at least two (2) nodes 162, and each edge 164 also describes (or is associated with) a relationship or association between the corresponding two (2) nodes 162 (such as server message block or SMB, remote desktop protocol or RDP, or logon). Because the attack graph 170 may be comprehensively built using the false positive cybersecurity detection characteristics 72 associated with one or more entities 74 (such as the groups/subgroups/batches 110/120 representing different devices, processes, users, IP addresses, etc., as explained with reference to FIGS. 5-9), the attack graph 170 may have different layers of entitative data. The attack graph 170 may thus have multiple layers, with each layer associated with a different source and/or a different entity 74.

The attack graph 170 reveals relationships between the nodes 162. For a given cybersecurity detection 34 and its associated entity 74 (such as the device where it happened or username associated with an identity detection), the false positive prediction service 52 identifies all possibly related entities 74 (as graph nodes 162) and leverage data from various sources (such as network events, network traffic, cloud activity logs, identity protection events, endpoint behavioral data) associated with each device within the entitative batch 110 for the time frame corresponding to the cybersecurity detection 34. Nodes 162 are added based on both historical and current detection data as well as entities 74 with no detection data to provide a comprehensive view of the incident. Edges 164 between nodes 162 are created based on interactions and relationships derived from both current and historical data. This includes direct interactions (such as process communication and network connections) as well as inferred relationships based on similar detection patterns or shared false positive cybersecurity detection characteristics 72. Based on the retrieved data, the false positive prediction service 52 constructs the graphical data 160 representing the multi-layered attack graph 170 representing the entities 74 and relationships between the entities 74 (processes, users, network activity) within the user's/customer's environment. Graph nodes 162 may also be represented as the cybersecurity detections 34 (e.g., one detection per node)—in addition to other entities 74 or replacing all other entities 74.

Nodal entities, as examples, may be determined by relevance. The service 30/52 may select the entity 74 as one of the nodes 162 using a relevance to detection and analysis. For example, the entity or entities 74 involved in the detections 34 (e.g., the entity 74 that is directly involved in or associated with detections 34) may be considered as a node 162. This includes devices, processes, users, network interfaces, IP addresses, and detection events. For example, if a process (Process-A) triggers a detection 34 on a device 36 (Device-1), both the process and the device 36 may be nodes 162 in the graph.

Nodal entities, as more examples, may be determined using potential. The entities 74 with significant relationship and interaction potential (such as entities that interact frequently or have meaningful relationships with others) may be nodes 162. This allows the graph (e.g., the graphical data 160) to capture and analyze these interactions effectively. For example, if User-B frequently logs into Device-2 and initiates Process-C, all three entities 74 (e.g., user, device, process) should be nodes, as their interaction may influence detection outcomes.

Nodal entities, as still more examples, may be determined using impact. Entities 74 that are critical to a security posture of a user/group/company or other environment (such as domain controllers, critical resources, key servers, or administrative users) may be nodes 162. Their actions or compromises can have widespread effects. For example, a domain controller (DC-1) should always be a node 162, as its interactions with other entities 74 can significantly impact the overall security of a network.

Nodal entities, as yet more examples, may be determined using contextual and/or historical importance. Entities 74 with historical significance (that is, entities 74 that have a history of being involved in detections 34, especially false positives) should be nodes 162. This helps in understanding patterns and preventing future FPs. For example, if a particular process (Process-D) has been flagged multiple times as a false positive, that process should be a node 162, allowing the graph (e.g., the graphical data 160) to track its process behavior over time.

Nodal entities, as even more examples, may be determined using network communications data. Some entities 74, for example, may have repetitive IP addresses, URLs, users/usernames, routers/modems/gateways/machines/devices, WIFI/BLUETOOTH/cellular networks, and other historical networking observances. Repetitive networking observances may be nodes 162 and/or edges 164 to track network communications over time.

Nodal entities, as more examples, may be determined using process communication. Suppose, for example, two (2) processes (such as Process-A and Process-B) are running on the same client device 36 (Device-X). Process-A spawns Process-B, and Process-B later communicates with an external server over a network. The nodes 162 and edges 164 may be created as direct interactions, for example, using the nodes 162 as the involved Process-A and Process-B. The edges 164 may be justified, as Process-A directly spawned Process-B, and an edge 164 is created between them to represent this direct process communication. The edge 164 may be labeled (such as “Process Execute”). For example, the edge 164 from Process-A to Process-B may be labeled with the label “Process Execute” to indicate the parent-child relationship.

Nodal entities, as more examples, may be determined using network interactions as the edges 164. Suppose, for example, that the nodes 162 involved are Process-B and External-Server. The edge 164 is justified, as Process-B initiates communication with the External-Server, so an edge 164 is created to represent this network interaction. The edge 164 may be labeled “Network Connection.” The edge 164, from Process-B to External-Server, in other words, may be labeled “Network Connection” indicating the communication.

Nodal entities, as more examples, may be determined using shared detection patterns. Suppose, for example, there are two (2) devices (such as Device-Y and Device-Z), and both have a process (Process-C) that has been repeatedly flagged for the same type of suspicious behavior. Both detections 34 are later determined to be FPs due to the same benign process behavior. The edge 164 may be selected using inferred relationships. The nodes 162 involved, for example, may be Device-Y, Device-Z, Process-C. As both Device-Y and Device-Z experienced the same detection pattern related to Process-C, and both were later identified as false positives, edges 164 are created between these entities 74 to capture the inferred relationship based on shared detection patterns. The edges 164 from Device-Y to Process-C and from Device-Z to Process-C may be labeled “SuspiciousBehaviorDetected”.

Nodal entities, as more examples, may be determined using the false positive characteristics 72. Suppose, for example, there are two (2) devices (such as Device-Y and Device-Z). Given that both devices shared similar false positive characteristics 72, an edge 164 is created directly between them, indicating this shared false positive connection. The edge 164 between Device-Y and Device-Z may be labeled with the label “Shared FP Characteristic”.

Nodal entities, as more examples, may be determined using Network Connections. Suppose an internal device (Device-A) communicates with several external IP addresses (IP-1, IP-2, IP-3) over the course of 1 day. These IP addresses are involved in similar patterns of traffic that have previously been associated with benign activities, but are sometimes flagged as suspicious. The nodes 162 involved are Device-A, IP-1, IP-2, IP-3. As Device-A has established direct communication with these IP addresses, edges 164 are created to represent these network connections. Edges 164 from Device-A to IP-1, IP-2, and IP-3 are labeled with the label “NetworkConnect” indicating the communication.

Nodal entities, as more examples, may be determined using Inferred Benign Traffic Pattern Edges. The nodes 162 involved are IP-1, IP-2, IP-3. Given that these IP addresses share a benign traffic pattern that is occasionally flagged as suspicious, edges 164 are created between them to capture this inferred relationship. Edges 164 between IP-1, IP-2, and IP-3 are labeled “Benign Traffic Pattern.”

Nodal entities, as more examples, may be determined using High/Low Interaction Rates Between Nodes. Suppose User-P interacts with multiple devices (Device-Q, Device-R) regularly. The frequency of these interactions is usually low, but suddenly spikes for Device-Q, leading to a detection. However, this spike is identified as a FP due to a known legitimate cause (e.g., a scheduled task). For Normal Interaction Rate Edges, the Nodes Involved: User-P, Device-R. An edge 164 is created between User-P and Device-R to represent the typical, low interaction rate. The edge 164 between User-P and Device-R is labeled with “UserLogon”. For the High Interaction Rate Edge, the Nodes Involved: User-P, Device-Q. An edge 164 is created between User-P and Device-Q to represent the sudden spike in interactions, which initially led to a detection 34. The Edge 164 between User-P and Device-Q is labeled with “SuspiciousUserLogon”.

Nodal entities, as still more examples, may be determined using the false positive characteristics 72. Suppose the nodes 162 involved are Device-Q, User-P. As the spike was determined to be a false positive due to a legitimate scheduled task, an additional edge 164 is created to represent this FP. The edge 164 between Device-Q and User-P is labeled with “ServiceAccountLogon”.

The graphical data 160 (such as the attack graph 170) may have multiple layers of nodal relationships. Because the false positive prediction service 52 may incorporate data from multiple different sources (such as network events, network traffic, the cloud service log 150, identity protection events, the endpoint computer activities/behaviors/contexts 40/42/76, and other false positive cybersecurity detection characteristics 72), the attack graph 170 may thus multiple different layers. Each layer may represent, or be associated with, a different source and/or a different entity 74. The graphical data 160 may simultaneously incorporate the source data, and thus the multiple different layers, as a single, overall graphical dataset. Indeed, each source data, and thus its corresponding layer, may be individually added or removed from the graphical data 160. Entitative relationships, as revealed by each source data and its corresponding layer, may be individually added or removed from the graphical data 160. When the server 26, for example (or some other computing member 28), generates the attack graph 170 for user visualization, the attack graph 170 may simultaneously display or plot each source data and its corresponding layer. The user may input commands or selections (perhaps via a user interface) that add/remove individual source layers from the attack graph 170. The user may peel back each visual layer to reveal the corresponding entitative relationship. The attack graph 170 may thus be generated and visually presented as a 2D or 3D plot having multiple layers of nodal relationships.

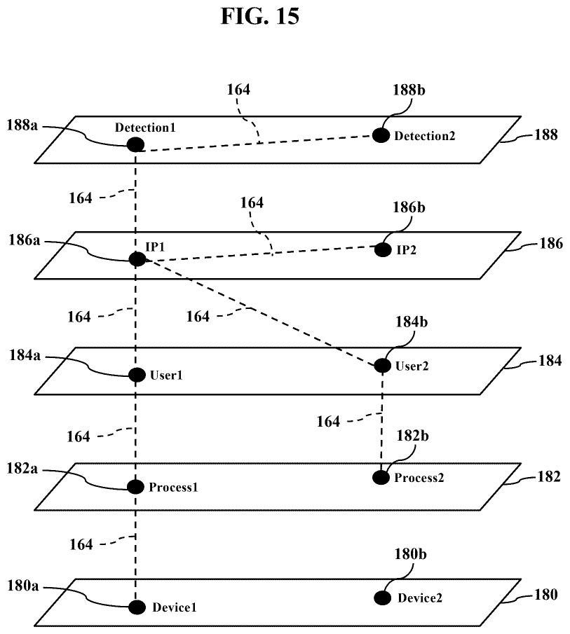

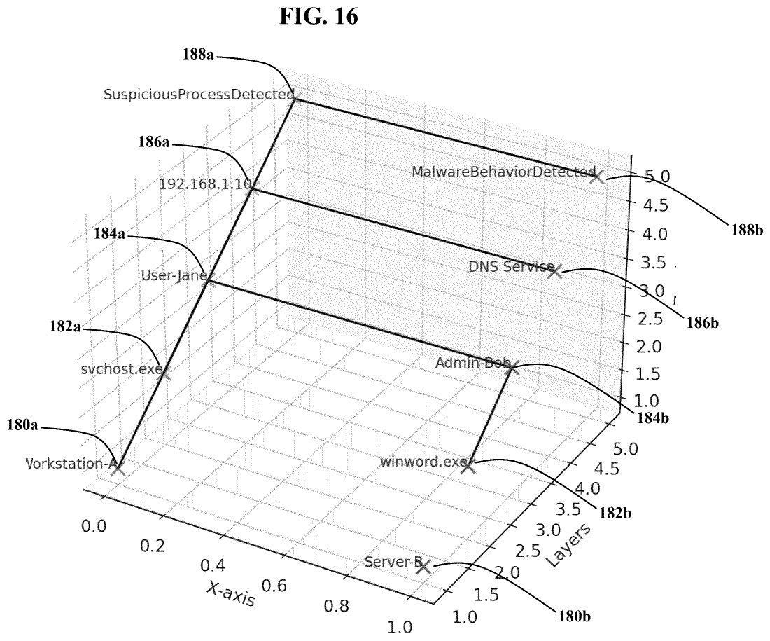

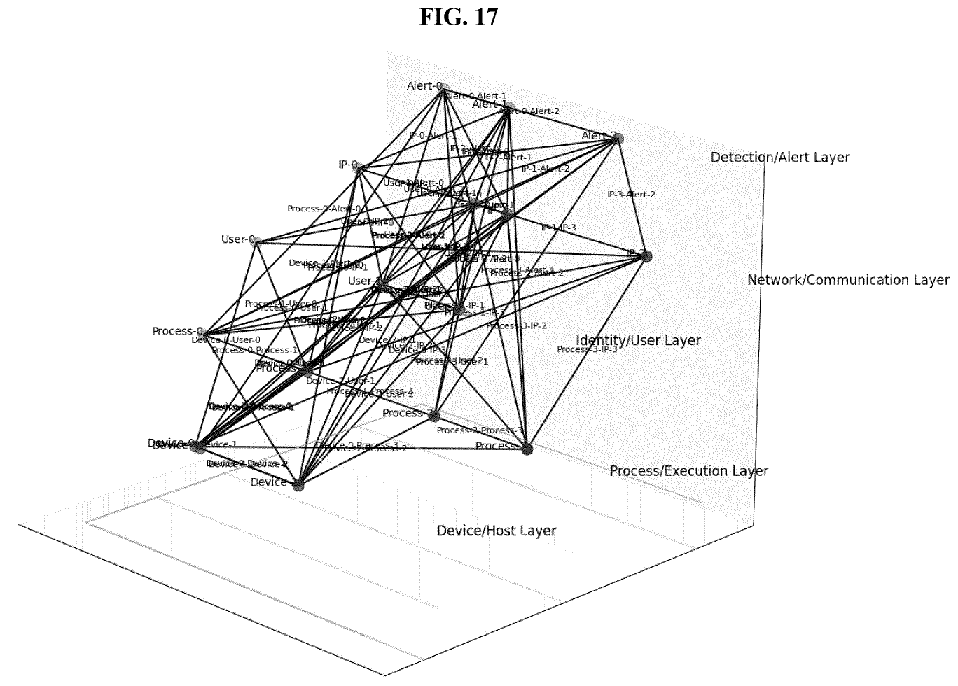

FIGS. 15-17 illustrate more examples of the graphical data 160. FIGS. 15-17 visually represents the graphical data 160 as three-dimensional attack graphs 170. FIGS. 15-16, though, only illustrate very simple three-dimensional examples of the attack graph 170. In actual, real world use, the three-dimensional attack graph 170 is far more complicated, as many nodes 162 and edges 164 are not visible. The cybersecurity service 30 and the machine learning model 90, easily learn from the complex three-dimensional attack graph 170 to identify false positives and breaches.

Returning to the simplified FIGS. 15-16, the three-dimensional attack graph 170 is simply illustrated. FIG. 15 illustrates five (5) entitative layers (such as a device layer 180, a process execution layer 182, an identity layer 184, a network layer 186, and a detection layer 188. Moreover, each layer 180-188 has two (2) corresponding intra-layer nodes (e.g., 180a-b, 182a-b, etc.). FIG. 16 illustrates a PYTHON generation of the same three-dimensional attack graph 170. The reader should note, though, that a computer system 22 (such as the rack server 50 illustrated in 13) need not represent the layered components. FIG. 16 thus omits the entitative layers 180-188 illustrated in FIG. 15. The edges 164 connected multiple nodes 180-188 having the entitative relationships (as above explained).

The cybersecurity service 30 thus reveals source/layer/node/edge/entity relationship(s). Let's assume an EDR (or XDR or NG SIEM) product (such as the endpoint cybersecurity sensory agent 132 illustrated in FIGS. 10-12) flags a suspicious process running on the client device 36. The cybersecurity service 30 determines whether this detection 34 is a false positive (FP). The cybersecurity service 30 generates the three-dimensional attack graph 170, perhaps having a few or many layers, with each layer representing different types of entities 74 and their relationships. Suppose, for example, that layer #1 represents a Device/Host Layer with Nodes/Entities representing devices or hosts within the network (e.g., Workstation-A, Server-B). This layer represents the physical or virtual devices within the network. The edge 164 connections between devices might represent network communication, shared resources, or hierarchical relationships (e.g., parent-child relationships between virtual machines and their hypervisor). Layer 2 may be a Process/Execution Layer with Nodes/Entities representing individual processes running on devices (e.g., svchost.exe, winword.exe, etc). This layer tracks the processes behaviors and execution flow. The edges 164 represent parent-child relationships between processes, process trees (e.g., one process spawning/executing another), or even network connections initiated by processes.

More layers may be generated. Layer 3, for example, may be an Identity/User Layer with Nodes/Entities representing user identities or accounts (e.g., User-Jane, Admin-Bob). This layer focuses on user activity, identity management, and authentication events. The edge 164 connections represent user logins, session initiation, role assignments, or actions taken by users on specific devices or within specific processes. Layer 4, for example, may be a Network/Communication Layer with Nodes/Entities representing IP addresses, network interfaces, and network services (e.g., 192.168.1.10, DNS Service, etc). This layer captures network traffic and communication patterns. The edges 164 represent communication flows, such as a process on one device communicating with another device over a specific port. Layer 5, for example, may be a Detection/Alert Layer having Nodes/Entities representing security alerts or detections 34 (e.g., SuspiciousOrAnomalousProcessTreeDetected, AbusingLegitimateApplicationLOLBinsDetected, RansomwareBehaviorDetected, RemoteAdminToolDetected, LateralMovementDetected, etc). This layer focuses on the security events flagged by various tools (e.g., EDR, XDR, NG SIEM, etc). The edge 164 connections may represent correlations between detections, such as one detection leading to or influencing another, or the same detection appearing across multiple devices or processes.

The cybersecurity service 30 reveals relationship(s) and edges across layers. Cross-Layer Relationships, for example, may flag a process (svchost.exe) in the Process/Execution Layer linked to a specific device (Workstation-A) in the Device/Host Layer. This same process might be associated with a user (User-Jane) who initiated it in the Identity/User Layer. The process could also be observed making a suspicious network connection (192.168.1.10) in the Network/Communication Layer. Finally, this behavior may trigger a detection (SuspiciousOrAnomalousProcessTreeDetected) in the Detection/Alert Layer. Edges Across Layers, as more examples, may be discovered. The edge 164 between svchost.exe in the Process Layer and Workstation-A in the Device Layer represents the process running on that device. The edge 164 between svchost.exe and User-Jane in the Identity Layer may represent the user who started the process. An edge 164 from svchost.exe to 192.168.1.10 in the Network Layer would represent the network activity initiated by the process. An edge 164 connecting svchost.exe to SuspiciousOrAnomalousProcessTreeDetected in the Detection Layer represents the detection event generated by the process's behavior.

The cybersecurity service 30 reveals Intra-Layer Relationships. Within the Process/Execution Layer, for example, edges 164 might exist between svchost.exe and winword.exe if one process spawns the other or if there's inter-process communication, or if svchost.exe injects malicious code into winword.exe. Within the Device/Host Layer, as another example, devices might be connected if they share network resources, are part of the same subnet, or have a direct communication link or there is a Lateral Movement between devices (e.g. user RDP′ing from device1 to device2). Within the Identity/User Layer, edges 164 could represent interactions between users, such as one user granting permissions to another, or role hierarchies or regular user elevates privileges, or admin user spawns app under service account to hide what they were doing.

Edges 164 may exist across or within layers. Cross-Layer Edges, for example, provide the necessary context for understanding the relationship between entities 74 that might appear unrelated in isolation. For example, knowing that a suspicious process is running on a device often used by an admin user could provide critical context in assessing the risk or legitimacy of the detection. These edges 164 help trace the flow of events across different dimensions (e.g., from user action to process execution to network activity), which is essential for accurate threat detection and reducing false positives. Intra-Layer Edges, as more examples, reveal relationships within the same category, such as multiple processes on the same device or user interactions within a particular system. Understanding these relationships helps in identifying patterns of behavior that could either confirm or contradict the suspicion of malicious activity. For example, multiple processes communicating in a known benign pattern might reduce the likelihood of an FP, whereas an unusual communication pattern might raise an alert.

As FIGS. 15-17 show, the graphical data 160 (such as the attack graph 170) may have multiple layers of nodal relationships. Because the false positive prediction service 52 may incorporate data from multiple different sources (such as network events, network traffic, the cloud service log 150, identity protection events, the endpoint computer activities/behaviors/contexts 40/42/76, and other false positive cybersecurity detection characteristics 72), the attack graph 170 may thus multiple different layers. This layered approach allows the cybersecurity service 40 to create a highly context-rich model of the incident in customer environment that can then be utilized (such as by the machine learning model 90) to find FPs (or even detect new patterns indicative of a breach).

The false positive prediction service 52 may use batch statistical analysis of detection frequency. The false positive prediction service 52 may group the cybersecurity detections 34 into batches (such as the entitative batches 110, as previously explained with reference to FIGS. 5 & 7-9). Batch analysis helps identifying commonalities and focuses on analyzing detection frequencies within batches of data, where a batch corresponds to a defined group of the cybersecurity detections 34, depending on detection context (such as user specific detection from IDP and/or EDR detections of processes on a managed devices) processed during a specified time interval. The false positive prediction service 52 may group the cybersecurity detections 34 that are related, such as by the type of detection, entities involved, or other shared characteristics (such as the entitative batches 110). Each group or batch may include a set of related entities 74, such as devices, users, and/or processes. The false positive prediction service 52 may analyze the frequency of all cybersecurity detections 34 occurring within a batch over a specified time interval. Statistical analysis is then performed to identify the cybersecurity detections 34 that frequently occur within the batch. The false positive prediction service 52 thus identifies statistical insights for common or recurring detections. Each batch, defined by a group of similar entities (e.g. devices, users, processes) helps in structuring the attack graph 170. These entities 74 and their interactions (edges 164) are embedded in the attack graph 170 based on the commonalities identified in the batch analysis (shared attributes, similar types, etc.).

The graphical data 160 may incorporate statistical edge weighting. The graphical data 160 (illustrated as the attack graph 170) has the nodes 162 and the interconnecting edges 164. The edges 164 may be weighted with the edge weights 166 representing the false positive cybersecurity detection characteristics 72 associated with the entity/entities 74. The false positive prediction service 52 may assign the edge weights 166 based on the statistical analysis of detection frequency (based on the analysis from batched detections, such as the entitative batches 110). The edge weights 166 may thus reflect the significance or strength of relationships. Higher values for the edge weights 166 are assigned to connections, indicating stronger or more relevant connections for the analysis of false positives (such as the cybersecurity detections 34 that frequently occur on multiple devices or occurring in patterns). The edge weights 166, as examples, may provide statistical context for graph neural networks (or GNNs). The false positive prediction service 52 may thus identify the high-probability false positive cybersecurity detections 20 within the batch (such as the entitative batch 110) by using the statistical weighting of the graphical edges 164 and the analysis by GNNs. Overall this task helps prioritize the examination of relationships that are more likely to contribute to false positives. The edge weights 166 are assigned not just based on the occurrence/count of the cybersecurity detections 34, but also taking into account the timing of the cybersecurity detections 34 (for example, more recent cybersecurity detections 34 could be given higher weights). The cybersecurity detections 34 may be aggregated based on similarity or type before assigning weights. Multiple cybersecurity detections 34 may have different weights and create different edges 164 between nodes 162. Even if the edge 164 itself is not directly related to the detection entity 74, the interaction between nodes 162 might still provide valuable context that influences the likelihood of false positives.

The false positive prediction service 52 may integrate statistical context into the machine learning model 90. Because the machine learning model 90 may be trained using the graphical data 160, the false positive prediction service 52 may utilize graph machine learning (or graph ML). The false positive prediction service 52, for example, applies graph ML (such as GCN, GNN, or other supervised or semi-supervised algorithm where the false positive cybersecurity predictions 78 are determined at the nodes 162 or graph level) on the graphical data 160. The false positive prediction service 52 analyzes the multi-layered attack graph 170, for example, by incorporating the statistical edge weights 166 assigned to the edges 164. These edge weights 166 encode the likelihood of the cybersecurity detection 34 being a false positive based on its characteristics (patterns, prevalence, occurrences, and other false positive cybersecurity detection characteristics 72). This statistical context enhances the graph ML ability to identify high-probability false positives within the user's/customer's environment. Graph ML provides a powerful mechanism for pattern recognition within the graphical data 160 and is excellent at handling the complex structures and relationships represented in the attack graph 170. The graph ML learns from network topology, the nodes 162, node features, the edge weights 166, and other graphical data 160 to identify patterns indicative of false positive cybersecurity detection characteristics 72.

Conventional cybersecurity schemes require hours, or even days, of analysis. In general, tracking an adversary through a user's or company's network infrastructure, analyzing an active breach, and generating accurate and meaningful XDR detections (or incidents) is a complex and challenging task. Cyber breaches have evolved to become highly sophisticated, often utilizing advanced techniques that easily evade conventional security measures. Cyber attackers use a wide range of attack vectors (such as phishing emails, malicious attachments, drive-by downloads, and supply chain attacks) that require unique detection mechanisms. Attackers continuously adapt and change to avoid detection. Modern organizations generate massive amounts of IT data that must be processed and analyzed to identify meaningful patterns and anomalies. Threat analysts thus face the burden of manually analyzing a vast amount of event data from various sources to identify potential threats. Conventional cybersecurity schemes are thus time-consuming and may require hours (or even days) to build a full picture of what occurred.

The false positive prediction service 52, though, compresses hours, or even days, of analysis into minutes. The false positive prediction service 52 may be performed within minutes of receipt of the cybersecurity detection 34. The false positive prediction service 52 detects novel lateral movement, explains the cybersecurity detection 34, and generates a summary of the cybersecurity attack. The graphical data 160 (and thus the attack graph 170), for example, accelerates analysis and builds a rich corpus of cybersecurity data (such as the graphical data 160). The normal operation 44 is far more accurately described by predicting the false positive cybersecurity detections 20.

The false positive prediction service 52 may generate the attack graph 170 for display. The graphical data 160 (visually presented as the attack graph 170) represents all possible paths of an attack against the client device 36, a computer network, the cloud service 140, and other customer/client computer/network environments. The attack graph 170, for example, helps security teams understand the timeline of an attack, the compromised hosts and users, relationships between various assets in the customer environment, and how they may be vulnerable to an attack. The attack graph 170 shows all assets compromised by an adversary, incidents in progress, and detects an attack in progress. The attack graph 170 also maps out all of the possible paths that an attacker could take to compromise a particular asset or set of assets in an environment. The attack graph 170 takes into account the different attack vectors that could be used and heuristically identifies lateral movement, C2 communication, and data exfiltration techniques. The attack graph 170 scales to handle a large amount of data and quickly visualizes the full timeline and related entities of an attack by connecting suspicious entities 74 with the related assets (such as users, devices, and applications). The attack graph 170 identifies novel intrusions and provides comprehensive and contextual understanding of a security incident as well as serves as a unified view of all events, indicators, and entities involved in an attack. The attack graph 170 automatically correlates events from multiple sources to identify a complete chain of events. The attack graph 170 identifies the root cause of an incident and visualizes complex relationships between events and entities 74. Adversaries may be tracked across entire company infrastructure and pieces together a series of events to make sense of how a breach was executed and what assets were compromised. The false positive prediction service 52 thus self-discovers incidents (such as the true positive cybersecurity detections 34) that warrant investigation without requiring a manual trigger. The false positive prediction service 52 thus more accurately provides early warnings of emerging attacks.

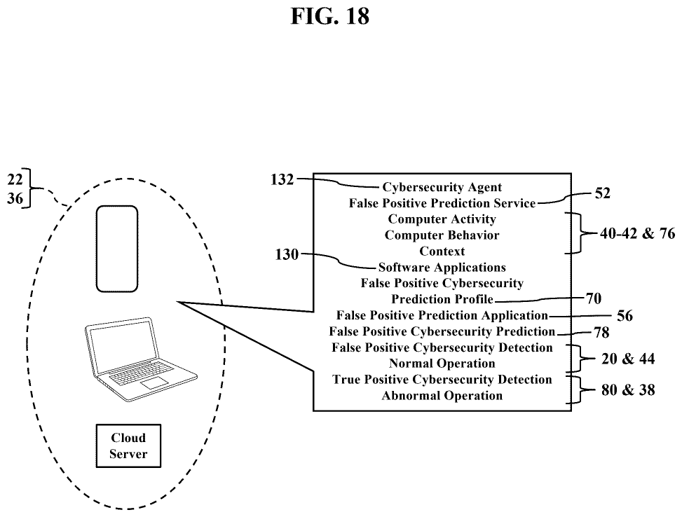

FIG. 18 illustrates examples of local endpoint prediction. Here the endpoint cybersecurity agent 132 may also provide the false positive prediction service 52. The endpoint cybersecurity agent 132 may cooperate with the local host operating system to monitor the computer system 22 (such as the client device 36). The client device's operating system notifies the endpoint cybersecurity agent 132 of events, processes, API calls, and other computer activities/behaviors/contexts 40/42/76 requested by the locally-stored software applications 130. The endpoint cybersecurity agent 132 may then compare the computer activities/behaviors/contexts 40/42/76 to the false positive cybersecurity detection profile 70. Here, though, some or all of the false positive cybersecurity detection profile 70 may be locally stored in the client device's local memory device (not shown for simplicity). The false positive cybersecurity detection profile 70, for example, may be locally generated and trained by the endpoint cybersecurity agent 132. The false positive cybersecurity detection profile 70, however, may additionally or alternatively be generated and pre-trained by the cloud computing network 24 (illustrated in FIG. 1) and distributed to clients in the field. The endpoint cybersecurity agent 132 may incorporate the false positive prediction application 56 as a module and locally generate the false positive cybersecurity prediction 78. If the false positive cybersecurity detection 20 is predicted, then the computer activities/behaviors/contexts 40/42/76 represents the normal operation 44. The endpoint cybersecurity agent 132 may thus allow, authorize, or approve the computer activities/behaviors/contexts 40/42/76. If, however, the true positive cybersecurity detection 80 is predicted, then the computer activities/behaviors/contexts 40/42/76 represent the abnormal operation 38. The endpoint cybersecurity agent 132 may generate and display/send warnings or other notifications. The endpoint cybersecurity agent 132 may also deny/halt/terminate the computer activities/behaviors/contexts 40/42/76 representing the abnormal operation 38. The endpoint cybersecurity agent 132 may also cause the software application(s) 130 to terminate.

The endpoint cybersecurity agent 132 may be an antimalware driver. The endpoint cybersecurity agent 132, for example, may have kernel-level components having kernel-level permissions to a kernel of the host client device's operating system. The endpoint cybersecurity agent 132 may additionally have user-mode components having user-level permissions to a user mode of the host client device's operating system. The endpoint cybersecurity agent 132 may include computer program, code, or instructions that scan and monitor the host client device's operating system for events, communications, processes, activities, behaviors, data values, usernames/logins, locations, contexts, and/or patterns. Because the endpoint cybersecurity agent 132 has kernel-level permissions, the endpoint cybersecurity agent 132 may monitor any kernel-level activity and/or any user-mode activity conducted by the client device 36. The endpoint cybersecurity agent 132 may register for and receive kernel-level notifications and call backs from the kernel.

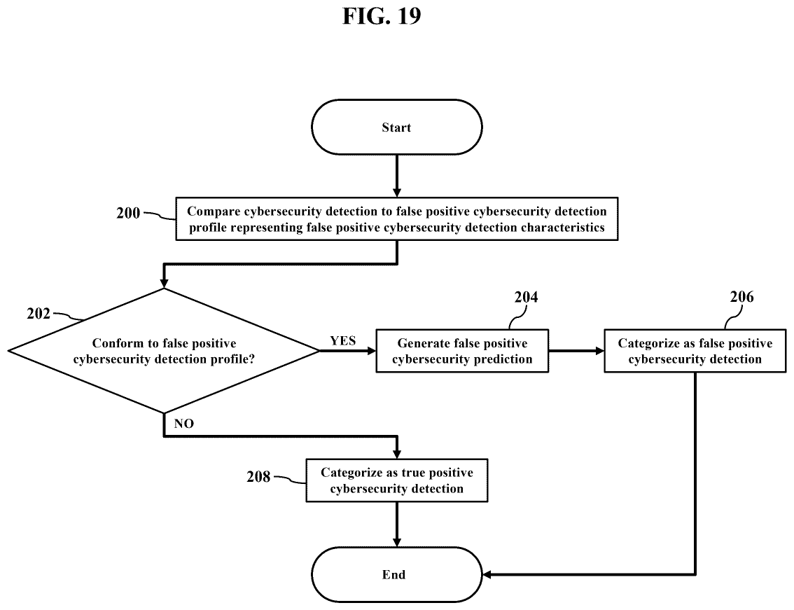

FIG. 19 illustrates examples of methods or operations that generate the false positive cybersecurity prediction 78. The cybersecurity detection 34 is compared to the false positive cybersecurity detection profile 70 representing the false positive cybersecurity detection characteristics 72 (Block 200). If the cybersecurity detection 34 conforms to the false positive cybersecurity detection profile 70 (Block 202), then generate the false positive cybersecurity prediction 78 (Block 204) and categorize the cybersecurity detection 34 as the false positive cybersecurity detection 20 (Block 206). If, however, the cybersecurity detection 34 fails to conform to the false positive cybersecurity detection profile 70 (Block 202), categorize the cybersecurity detection 34 as the true positive cybersecurity detection 80 (Block 208).

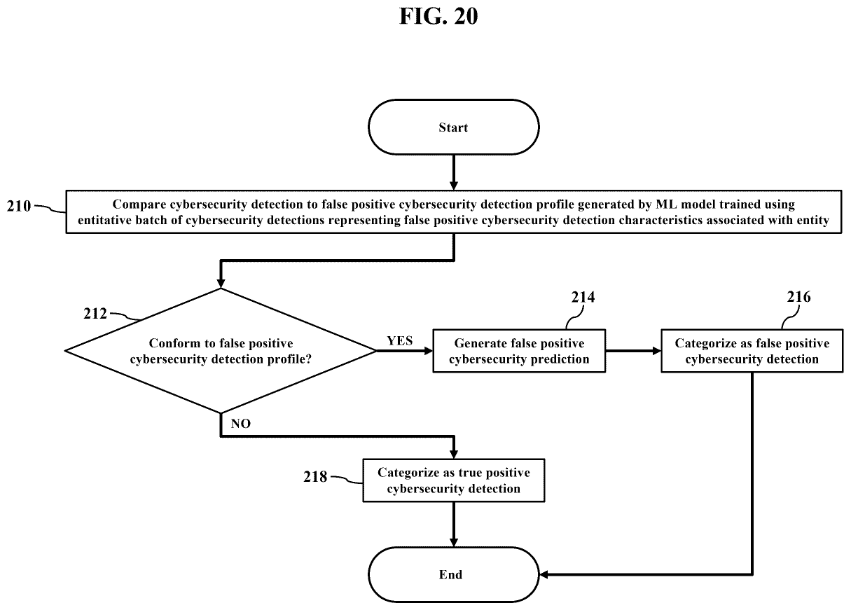

FIG. 20 illustrates more examples of methods or operations that generate the false positive cybersecurity prediction 78. The cybersecurity detection 34 is compared to the false positive cybersecurity detection profile 70 generated by the machine learning model 90 trained using the entitative batch 110 of cybersecurity detections representing the false positive cybersecurity detection characteristics 72 associated with the entity 74 (Block 210). If the cybersecurity detection 34 conforms to the false positive cybersecurity detection profile 70 (Block 212), then generate the false positive cybersecurity prediction 78 (Block 214) and categorize the cybersecurity detection 34 as the false positive cybersecurity detection 20 (Block 216). If, however, the cybersecurity detection 34 fails to conform to the false positive cybersecurity detection profile 70 (Block 212), categorize the cybersecurity detection 34 as the true positive cybersecurity detection 80 (Block 218).

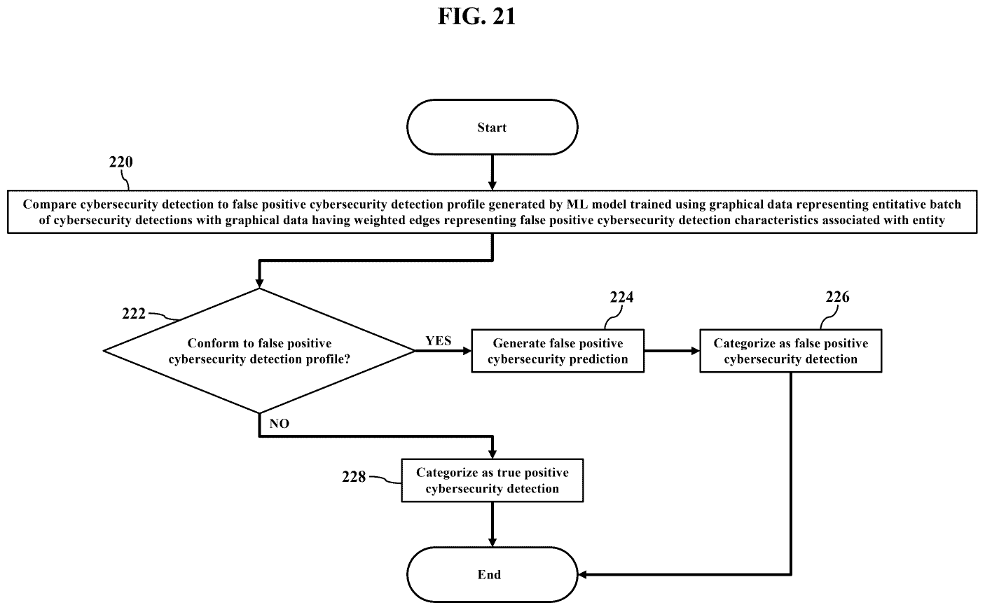

FIG. 21 illustrated more examples of methods or operations that generate the false positive cybersecurity prediction 78. The cybersecurity detection 34 is compared to the false positive cybersecurity detection profile 70 generated by the machine learning model 90 trained using the graphical data 160 representing the entitative batch 110 of cybersecurity detections, the graphical data 160 having the weighted edges 164 representing the false positive cybersecurity detection characteristics 72 associated with the entity 74 (Block 220). If the cybersecurity detection 34 conforms to the false positive cybersecurity detection profile 70 (Block 222), then generate the false positive cybersecurity prediction 78 (Block 224) and categorize the cybersecurity detection 34 as the false positive cybersecurity detection 20 (Block 226). If, however, the cybersecurity detection 34 fails to conform to the false positive cybersecurity detection profile 70 (Block 222), categorize the cybersecurity detection 34 as the true positive cybersecurity detection 80 (Block 228).

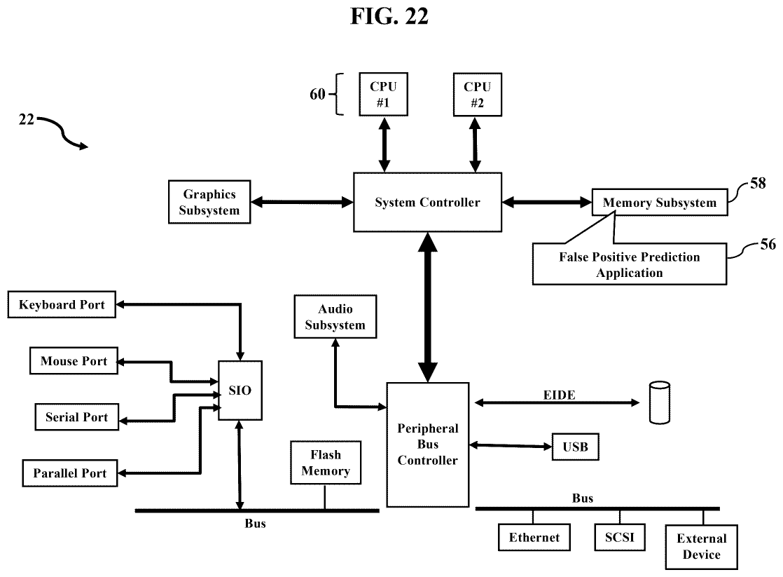

FIG. 22 illustrates a more detailed example of the operating environment. FIG. 22 is a more detailed block diagram illustrating the computer system 22. The false positive prediction application 56 is stored in the memory subsystem or device 58. One or more of the hardware processors 60 communicate with the memory subsystem or device 58 and execute the false positive prediction application 56. Examples of the memory subsystem or device 58 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 22 may have any embodiment. This disclosure mostly discusses the computer system 22 as the server 26 and the client device 36. The false positive prediction service 52, however, may be easily adapted to mobile computing, wherein the computer system 22 may be a smartphone, laptop or desktop computer, a switch/router, a tablet computer, or a smartwatch. The false positive prediction service 52 may also be easily adapted to other embodiments of smart devices, such as a television, an audio device, a remote control, and a recorder. The false positive prediction service 52 may also be easily adapted to still more smart appliances, such as washers, dryers, and refrigerators. Indeed, as cars, trucks, and other vehicles grow in electronic usage and in processing power, the false positive prediction service 52 may be easily incorporated into any vehicular controller.

The above examples of the false positive prediction service 52 may be applied regardless of communications networking technology and networking environment. The false positive prediction service 52 may be easily adapted to stationary or mobile devices having wide-area networking (e.g., 4G/LTE/5G/6G cellular), wireless local area networking (WI-FI®), near field, and/or BLUETOOTH capability. The false positive prediction service 52 may be applied to stationary or mobile devices utilizing any portion of the electromagnetic spectrum and any signaling standard (such as the IEEE 802 family of standards, GSM/CDMA/TDMA or any cellular standard, and/or the ISM band). The false positive prediction service 52, however, may be applied to any processor-controlled device operating in the radio-frequency domain and/or the Internet Protocol (IP) domain. The false positive prediction service 52 may be applied to any processor-controlled device utilizing a distributed computing network, such as the Internet (sometimes alternatively known as the “World Wide Web”), an intranet, a local-area network (LAN), and/or a wide-area network (WAN). The false positive prediction service 52 may be applied to any processor-controlled device utilizing power line technologies, in which signals are communicated via electrical wiring. Indeed, the many examples may be applied regardless of physical componentry, physical configuration, or communications standard(s).

Operating environments may utilize any processing component, configuration, or system. For example, the false positive prediction service 52 may be easily adapted to execute by a desktop, mobile, or server central/graphical processing unit 60 or chipset offered by INTEL®, ADVANCED MICRO DEVICES®, ARM®, APPLE®, TAIWAN SEMICONDUCTOR MANUFACTURING®, QUALCOMM®, or other manufacturer. The computer system 22 may even use multiple central CPUs/GPUs/cores or chipsets, which could include distributed processors or parallel processors in a single machine or multiple machines. The CPUs/GPUs/cores or chipsets can be used in supporting a virtual processing environment. The CPUs/GPUs/cores or chipsets could include a state machine or logic controller. When any of the CPUs/GPUs/cores or chipsets execute instructions to perform “operations,” this could include the CPUs/GPUs/cores or chipsets performing the operations directly and/or facilitating, directing, or cooperating with another device or component to perform the operations.

The false positive prediction service 52 may use packetized communications. When the computer system 22 and the cloud computing environment 24 communicate, information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The false positive prediction service 52 may utilize any signaling standard. The cloud computing environment 24 may mostly use wired networks to interconnect the network members 28. However, the cloud computing environment 24 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 24 may also utilize other standards, such as the I.E.E.E. 802 family of standards, the Industrial, Scientific, and Medical band of the electromagnetic spectrum, BLUETOOTH®, low-power or near-field, and any other standard or value.

The false positive prediction service 52 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for generating the false positive cybersecurity prediction 78, as the above paragraphs explain.

The diagrams, schematics, illustrations, and tables represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that generates a false positive cybersecurity prediction, comprising:
comparing, by the computer system, a cybersecurity detection to a false positive cybersecurity detection profile representing false positive cybersecurity detection characteristics; and
generating, by the computer system, the false positive cybersecurity prediction based on the comparing of the cybersecurity detection to the false positive cybersecurity detection profile representing the false positive cybersecurity detection characteristics.

2. The method of claim 1, further comprising generating the false positive cybersecurity prediction using a machine learning model.

3. The method of claim 1, further comprising generating the false positive cybersecurity detection profile using a machine learning model.

4. The method of claim 1, further comprising generating the false positive cybersecurity prediction using a machine learning model trained using the false positive cybersecurity detection characteristics associated with false positive cybersecurity detections.

5. The method of claim 1, further comprising generating the false positive cybersecurity prediction using a machine learning model trained using three-dimensional graphical data representing the false positive cybersecurity detection characteristics associated with false positive cybersecurity detections.

6. At least one computer system that generates a false positive cybersecurity prediction, comprising:
at least one central processing unit; and
at least one memory device storing instructions that, when executed by the at least one central processing unit, perform operations, the operations comprising:
comparing a cybersecurity detection to a false positive cybersecurity detection profile generated by a machine learning model trained using an entitative batch of false positive cybersecurity detections representing false positive cybersecurity detection characteristics associated with an entity; and
generating the false positive cybersecurity prediction based on the comparing of the cybersecurity detection to the false positive cybersecurity detection profile generated by the machine learning model.

7. The at least one computer system of claim 6, wherein the operations further comprise determining the cybersecurity detection conforms to the false positive cybersecurity detection profile.

8. The at least one computer system of claim 7, wherein the operations further comprise categorizing the cybersecurity detection as false positive.

9. The at least one computer system of claim 6, wherein the operations further comprise determining the cybersecurity detection fails to conform to the false positive cybersecurity detection profile.

10. The at least one computer system of claim 9, wherein the operations further comprise categorizing the cybersecurity detection as true positive.

11. The at least one computer system of claim 6, wherein the operations further comprise grouping the false positive cybersecurity detections based on the entity.

12. The at least one computer system of claim 6, wherein the operations further comprise grouping the false positive cybersecurity detections based on devices associated with the entity.

13. The at least one computer system of claim 6, wherein the operations further comprise grouping the false positive cybersecurity detections based on users associated with the entity.

14. The at least one computer system of claim 6, wherein the operations further comprise grouping the false positive cybersecurity detections based on an operating system process associated with the entity.

15. A memory device storing instructions that, when executed by at least one central processing unit, perform operations that generate a false positive cybersecurity prediction, the operations comprising:
comparing a cybersecurity detection to a false positive cybersecurity detection profile generated by a graph machine learning model trained using graphical data representing an entitative batch of false positive cybersecurity detections, the graphical data having weighted edges representing false positive cybersecurity detection characteristics associated with an entity; and
generating a false positive cybersecurity prediction based on the comparing of the cybersecurity detection to the false positive cybersecurity detection profile generated by the machine learning model.

16. The memory device of claim 15, wherein the operations further comprise determining the cybersecurity detection conforms to the false positive cybersecurity detection profile.

17. The memory device of claim 16, wherein the operations further comprise categorizing the cybersecurity detection as false positive.

18. The memory device of claim 15, wherein the operations further comprise grouping the false positive cybersecurity detections based on the entity.

19. The memory device of claim 15, wherein the operations further comprise grouping the false positive cybersecurity detections based on devices associated with the entity.

20. The memory device of claim 15, wherein the operations further comprise grouping the false positive cybersecurity detections based on users associated with the entity.
